(19) United States
(12) Patent Application Publication
(10) Pub. No.: US 2011/0096318 A1
(43) Pub. Date: Apr. 28, 2011

(54) EXPOSURE APPARATUS AND DEVICE FABRICATING METHOD

(75) Inventor: Hiromitsu YOSHIMOTO, Saitama-shi (JP)

(73) Assignee: NIKON CORPORATION, Tokyo (JP)

(21) Appl. No.: 12/887,799

(22) Filed: Sep. 22, 2010

Related U.S. Application Data
(60) Provisional application No. 61/272,471, filed on Sep. 28, 2009.

(51) Int. Cl. G03B 27/58

(52) U.S. Cl. 355/72; 355/77

(57) ABSTRACT

A first stage unit and a second stage unit are disposed adjacently in a second direction. A first holding member, which is supported by a first stage unit, and a second holding member, which is supported by the second stage unit, move in a direction parallel to the second direction while maintaining the state wherein they are in either close proximity or contact at end parts on the second direction side and transition from a first state, wherein a liquid is held between the object on the first holding member and the optical system, to a second state, wherein the liquid is held between the object on the second holding member and the optical system.

### CROSS-REFERENCE TO RELATED APPLICATION

This application is a non-provisional application claiming priority to and the benefit of U.S. provisional application No. 61/272,471, filed Sep. 28, 2009. The entire contents of which are incorporated herein by reference.

### BACKGROUND

The present invention relates to an exposure apparatus and a device fabricating method, and more particularly relates to an exposure apparatus that is used in lithographic processes that fabricate electronic devices, such as semiconductor devices, and to a device fabricating method that uses the exposure apparatus.

Conventionally, lithographic processes that fabricate electronic devices (i.e., microdevices), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

Wafers that undergo exposure and substrates like glass plates that are used in various exposure apparatuses have been increasing in size with time (e.g., wafers have increased in size every 10 years). Presently, the mainstream wafer has a diameter of 300 mm, and the era of a wafer with a diameter of 450 mm is nearing. When the industry transitions to the 450 mm wafer, the number of dies (i.e., chips) yielded by one wafer will increase to more than double that of the current 300 mm wafer, which will help reduce costs. In addition, it is anticipated that the effective utilization of energy, water, and other resources will further reduce the total resources consumed per chip.

The increasing miniaturization of semiconductor devices over time has created a demand for exposure apparatuses with greater resolving power. Means of improving resolving power include shortening the wavelength of the exposure light and increasing the numerical aperture of the projection optical system (i.e., increasing NA). Using an immersion exposure, wherein a wafer is exposed through the projection optical system and a liquid, effectively maximizes the actual numerical aperture of that projection optical system.

Moreover, given that increasing the size of the wafer to 450 mm will also increase the number of dies (i.e., chips) yielded by one wafer, it is highly probable that the time required to expose one wafer will increase, thereby reducing throughput. Accordingly, throughput must be improved as much as possible; one conceivable method of doing so is to adopt a twin stage system wherein an exposing process is performed on a wafer on one wafer stage while another process, such as a wafer exchanging process or a wafer aligning process, is performed on a separate wafer stage.

Namely, to simultaneously improve resolving power and throughput, it is conceivable to adopt a local liquid immersion type exposure apparatus that is configured with twin stages. The exposure apparatus disclosed in, for example, U.S. Patent Application Publication No. 2008/0088843 is one known conventional example of such an exposure apparatus.

### SUMMARY

However, to maximize throughput in the local liquid immersion type exposure apparatus disclosed in Patent Document 1, it is necessary to maintain an immersion space, which is formed below the projection optical system, continuously; consequently, it is necessary to constantly and replaceably dispose some kind of member directly below the projection optical system. Accordingly, it is preferable that the replaceable arrangement of this member contribute to improving the throughput of the apparatus.

A purpose of aspects of the present invention is to provide an exposure apparatus and a device fabricating method that can help improve throughput.

An exposure apparatus according to an aspect of the present invention provides an exposure apparatus that exposes an object with an energy beam through an optical system and a liquid and comprises: a plurality of holding members, which hold the object; a first stage unit, which movably supports the holding members in an area within a two dimensional plane that includes a first position directly below the optical system; and a second stage unit, that movably supports the holding members independently of the first stage unit in an area within the two dimensional plane that includes the first position and a second position, which is spaced apart from the first position; wherein, each of the first and second stage units comprises: first moving bodies, which comprise guide members that extend in first directions, that move in second directions, which are substantially orthogonal to the first directions; and two second moving bodies, which are provided such that they are capable of moving independently in the first directions along the guide members, that move in the second directions together with the guide members by the movement of the first moving bodies; the first stage unit and the second stage unit are disposed adjacently in the second directions; and the first holding member, which is supported by the first stage unit, and the second holding member, which is supported by the second stage unit, move in directions parallel to the second directions while maintaining the state wherein they are in either close proximity or contact at end parts on the second directions side and transition from a first state, wherein a liquid is held between the object on the first holding member and the optical system, to a second state, wherein the liquid is held between the object on the second holding member and the optical system.

A device fabricating method according to an aspect of the present invention provides a device fabricating method that comprises the steps of: exposing an object using an exposure apparatus of the present invention; and developing the exposed object.

According to aspects of the present invention, the throughput of a local liquid immersion type exposure apparatus can be improved.

### BRIEF DESCRIPTION OF THE DRAWINGS

FIG. 1 schematically shows the configuration of an exposure apparatus of one embodiment.

FIG. 2 is a partial plan view that schematically shows the exposure apparatus shown in FIG. 1.

FIG. 3 is an external oblique view of a wafer stage provided by the exposure apparatus shown in FIG. 1.

FIG. 4 is a partial, exploded oblique view of the wafer stage shown in FIG. 3.

FIG. 5A is a side view, viewed from the −Y direction, that shows the wafer stage provided by the exposure apparatus shown in FIG. 1.

FIG. 5B is a plan view that shows the wafer stage.

FIG. 6A is a block diagram of an X head.

FIG. 6B is for explaining the arrangement of the X head and Y heads inside a measuring arm.

FIG. 7A is an oblique view that shows a tip part of the measuring arm.

FIG. 7B is a plan view, viewed from the +Z direction, of the upper surface of the tip part of the measuring arm.

FIG. 8A is a plan view that shows both a fine motion stage, which is indicated by chain double dashed lines, and a transport stage.

FIG. 8B is a side view, viewed from the +Y direction, that shows the fine motion stage, indicated by the chain double dashed lines, and the transport stage.

FIG. 9 is a block diagram that shows the configuration of a control system of the exposure apparatus shown in FIG. 1.

FIG. 10A is for explaining a method of driving a wafer during a scanning exposure.

FIG. 10B is for explaining a method of driving the wafer during stepping.

FIG. 11A is a view for explaining parallel processes that are performed using the fine motion stages.

FIG. 11B is a view for explaining parallel processes that are performed using the fine motion stages.

FIG. 11C is a view for explaining parallel processes that are performed using the fine motion stages.

FIG. 12 is a plan view of the exposure apparatus that corresponds to the state shown in FIG. 11A.

FIG. 13 is a plan view of the exposure apparatus that corresponds to the state shown in FIG. 11B.

FIG. 14 is a plan view of the exposure apparatus that corresponds to the state shown in FIG. 11C.

FIG. 15A is a view for explaining the parallel processes performed using the fine motion stages.

FIG. 15B is a view for explaining the parallel processes performed using the fine motion stages.

FIG. 15C is a view for explaining the parallel processes performed using the fine motion stages.

FIG. 16 is a plan view of the exposure apparatus that corresponds to the state shown in FIG. 15A.

FIG. 17 is a plan view of the exposure apparatus that corresponds to the state shown in FIG. 15B.

FIG. 18 is a plan view of the exposure apparatus that corresponds to the state shown in FIG. 15C.

FIG. 19 is a view for explaining the parallel processes performed using the fine motion stages.

FIG. 20 is a view for explaining the parallel processes performed using the fine motion stages.

FIG. 21 is a view for explaining the parallel processes performed using the fine motion stages.

FIG. 22 is a view for explaining the parallel processes performed using the fine motion stages.

FIG. 23 is a view for explaining the parallel processes performed using the fine motion stages.

FIG. 24 is a view for explaining the parallel processes performed using the fine motion stages.

FIG. 25 is a plan view that shows the configuration of the exposure apparatus according to a modified example of the embodiment shown in FIG. 1 and is a view for explaining the parallel processes that are performed using three fine motion stages.

FIG. 26 is a view for explaining the parallel processes performed by the exposure apparatus according to the modified example using the three fine motion stages.

FIG. 27 is a view for explaining the parallel processes performed by the exposure apparatus according to the modified example using the three fine motion stages.

FIG. 28 is a view for explaining the parallel processes performed by the exposure apparatus according to the modified example using the three fine motion stages.

FIG. 29 is a view for explaining the parallel processes performed by the exposure apparatus according to the modified example using the three fine motion stages.

FIG. 30 is a flow chart that depicts one example of a process of fabricating a microdevice.

FIG. 31 depicts one example of the detailed process of a wafer processing step described in FIG. 30.

### DESCRIPTION OF EMBODIMENTS

### (Exposure Apparatus)

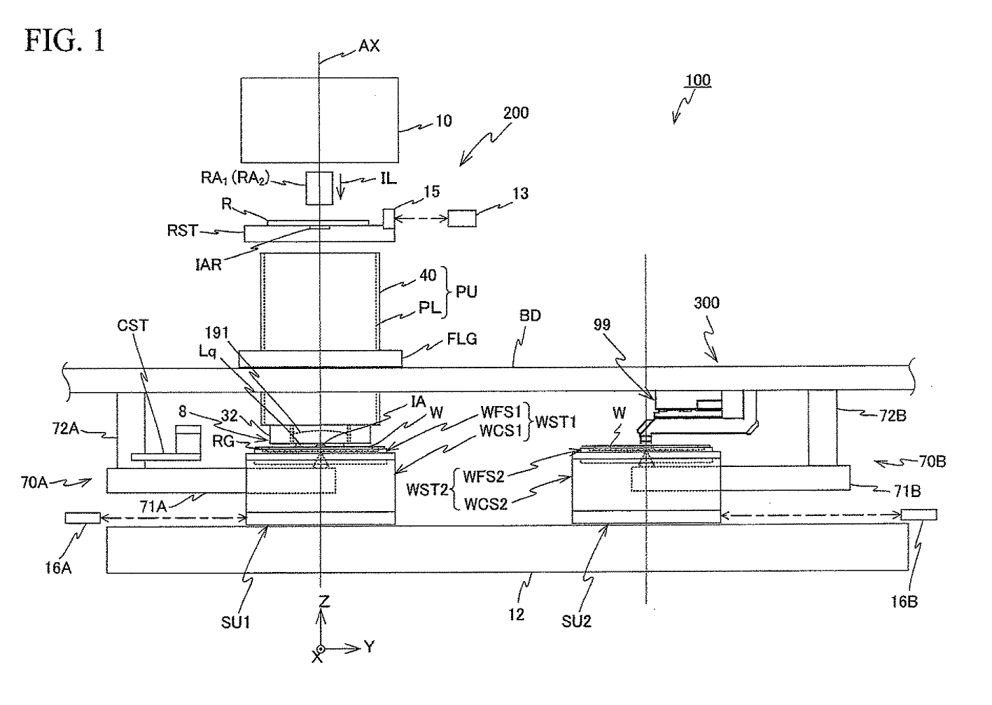

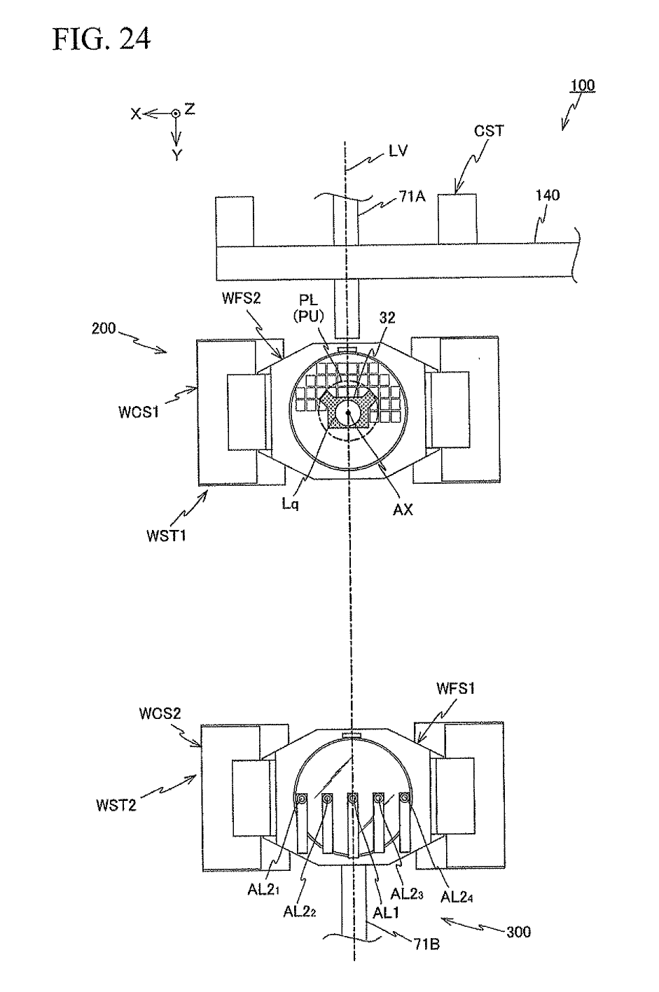

The following text explains an exposure apparatus and a device fabricating method according to embodiments, referencing FIG. 1 through FIG. 31.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

As shown in FIG. 1, the exposure apparatus 100 comprises: an exposure station 200 (i.e., a processing position), which is disposed on a base plate 12 in the vicinity of the −Y side end part thereof; a measurement station 300 (i.e., a processing position), which is disposed on the base plate 12 in the vicinity of the +Y side end part thereof; a transport stage CST, which is disposed on a −Y side end part of the exposure station 200; a stage apparatus ST, which comprises two wafer stages WST1, WST2; and a control system that controls these elements. Here, the base plate 12 is supported substantially horizontally (i.e., parallel to the XY plane) on a floor surface by a vibration isolating mechanism (not shown). The base plate 12 comprises a flat plate shaped member, whose upper surface is finished to an extremely high degree of flatness, and serves as a guide surface when the wafer stages WST1, WST2 are moved.

The exposure station 200 comprises an illumination system 10, a reticle stage RST, a projection unit PU, and a local liquid immersion apparatus 8.

As disclosed in, for example, U.S. Patent Application Publication No. 2003/0025890, the illumination system 10 comprises an illumination optical system that comprises: a light source; a luminous flux intensity uniformizing optical system, which includes an optical integrator and the like; and a reticle blind (none of which are shown). The illumination system 10 illuminates, with illumination light IL (i.e., exposure light, an energy beam, etc.) at a substantially uniform luminous flux intensity, a slit shaped illumination area IAR, which is defined by a reticle blind (also called a masking system), on a reticle R. Here, as one example, ArF excimer laser light (with a wavelength of 193 nm) is used as the illumination light IL.

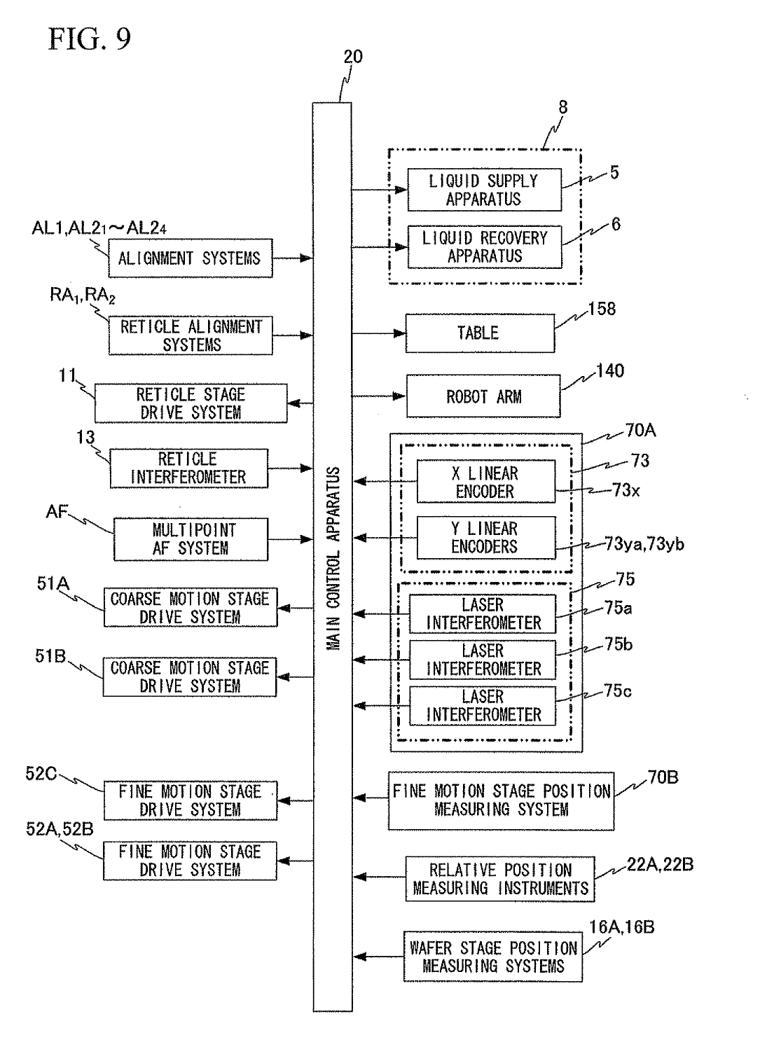

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 9) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

A reticle laser interferometer 13 (hereinbelow, called a “reticle interferometer”) continuously detects, with a resolving power of, for example, approximately 0.25 nm, the position (including rotation in the θz directions) of the reticle stage RST within the XY plane via movable mirrors 15, which are fixed to the reticle stage RST. Measurement values of the reticle interferometer 13 are sent to a main control apparatus 20 (not shown in FIG. 1; refer to FIG. 9).

The projection unit PU is disposed below the reticle stage RST in FIG. 1. The projection unit PU is supported by a main frame BD, which is supported horizontally by a support member (not shown), via a flange part FLG, which is provided to an outer circumferential part of the projection unit PU. The projection unit PU comprises a lens barrel 40 and the projection optical system PL, which comprises a plurality of optical elements that are held inside the lens barrel 40. A dioptric optical system that is, for example, telecentric on both sides and has a prescribed projection magnification (e.g., ¼×, ⅕×, or ⅛×) is used as the projection optical system PL. Consequently, when the illumination light IL from the illumination system 10 illuminates the illumination area IAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area IAR (i.e., a reduced image of part of the circuit pattern) on a wafer W (i.e., an object), which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR.

Furthermore, a scanning exposure is performed on one shot region (i.e., a block area) on the wafer W, and a pattern of the reticle R is thereby transferred to that shot region by synchronously driving the reticle stage RST, which holds the reticle R, and a wafer fine motion stage WFS1 (or WFS2) (i.e., a holding member; hereinbelow, abbreviated as “fine motion stage”), which holds the wafer W, so as to move the reticle R relative to the illumination area IAR (i.e., the illumination light IL) in the scanning directions (i.e., the Y axial directions) and to move the wafer W relative to the exposure area IA (i.e., the illumination light IL) in the scanning directions (i.e., the Y axial directions). Namely, in the present embodiment, the pattern of the reticle R is created on the wafer W by the illumination system 10 and the projection optical system PL, and that pattern is formed on the wafer W by exposing a sensitive layer (i.e., a resist layer) on the wafer W with the illumination light IL.

The local liquid immersion apparatus 8 (i.e., the liquid immersion apparatus) comprises a liquid supply apparatus 5 and a liquid recovery apparatus 6 (both of which are not shown in FIG. 1; refer to FIG. 9) as well as a nozzle unit 32 (i.e., a liquid immersion member). As shown in FIG. 1, the nozzle unit 32 is suspended from the main frame BD, which supports the projection unit PU and the like, via a support member (not shown) such that the nozzle unit 32 surrounds a lower end part of the lens barrel 40 that holds the optical element (i.e., optical member)—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 9), which via the nozzle unit 32 supplies a liquid Lq to the space between the tip lens 191 and the wafer W, and the liquid recovery apparatus 6 (refer to FIG. 9), which via the nozzle unit 32 recovers the liquid from the space between the tip lens 191 and the wafer W. At this time, the main control apparatus 20 controls the liquid supply apparatus 5 and the liquid recovery apparatus 6 such that the amount of the liquid supplied and the amount of the liquid recovered are always equal. Accordingly, a fixed amount of a liquid Lq (refer to FIG. 1) is continuously being replaced and held between an emergent surface of the tip lens 191 and the wafer W. In the present embodiment, it is understood that pure water, through which ArF excimer laser light (i.e., light with a wavelength of 193 nm) transmits, is used as the abovementioned liquid.

In addition, the exposure station 200 is provided with a fine motion stage position measuring system 70A (i.e., a measuring apparatus, first measuring apparatus) that comprises a measuring arm 71A, which is supported in a substantially cantilevered state (i.e., the vicinity of one-end part is supported) from the main frame BD via a support member 72A. However, for the sake of convenience, the fine motion stage position measuring system 70A will be explained after the fine motion stages (discussed below) are explained.

The measurement station 300 comprises: an alignment apparatus 99, which is fixed to the main frame BD in a suspended state; and a fine motion stage position measuring system 70B (i.e., a measuring apparatus, second measuring apparatus) that comprises a measuring arm 71B, which is supported in a cantilevered state (i.e., the vicinity of one-end part is supported) from the main frame BD via a support member 72B. The fine motion stage position measuring system 70B is configured identically to the fine motion stage position measuring system 70A discussed above, except that it is oriented in the opposite direction.

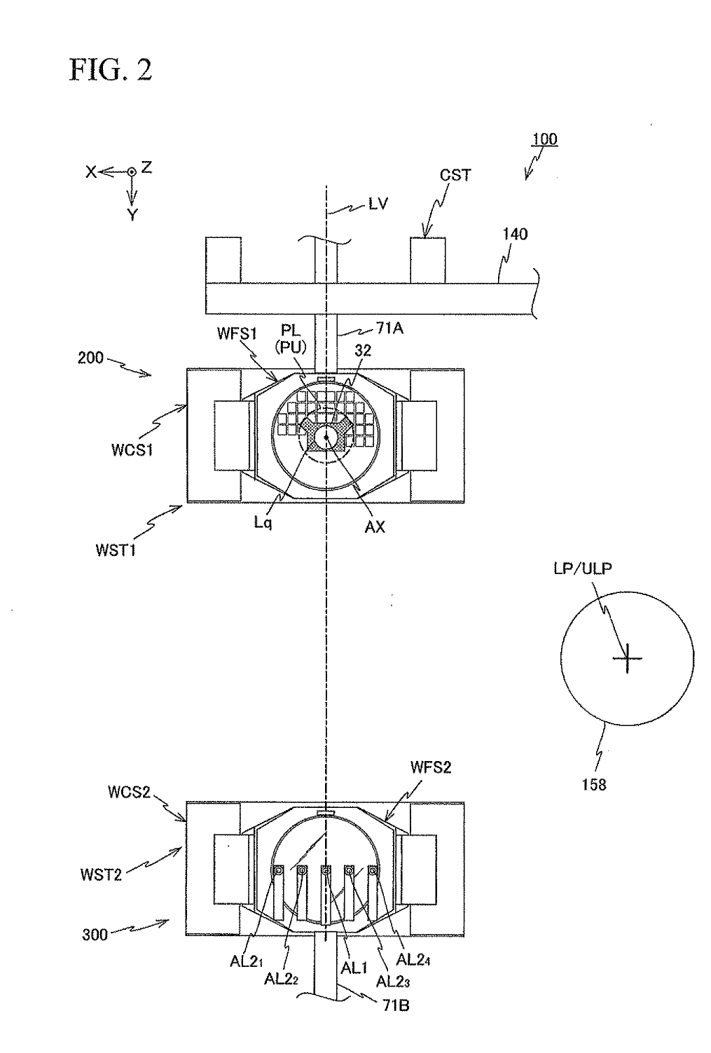

The alignment apparatus 99 comprises five alignment systems AL1, AL2₁-AL2₄ as shown in FIG. 2. In detail, as shown in FIG. 2, the primary alignment system AL1 is disposed along a straight line LV (hereinbelow, called a reference axis), which is parallel to the Y axis and passes through the center of the projection unit PU (i.e., the optical axis AX of the projection optical system PL; in the present embodiment, this center also coincides with the center of the exposure area IA discussed above), such that its center of detection is positioned spaced apart from the optical axis AX on the +Y side by a prescribed distance. The secondary alignment systems AL2₁, AL2₂ and AL2₃, AL2₄, whose centers of detection are disposed substantially symmetrically with respect to the reference axis LV, are provided on either side of the primary alignment system AL1 in the X axial directions such that the primary alignment system AL1 is interposed therebetween. Namely, the centers of detection of the five alignment systems AL1, AL2₁-AL2₄ are disposed along the X axial directions. The secondary alignment systems AL2₁, AL2₂, AL2₃, AL2₄ are held by a holding apparatus (i.e., a slider), which is capable of moving within the XY plane. Each of the alignment systems AL1, AL2₁-AL2₄ is an image processing type field image alignment (FIA) system. The signals that represent the images captured by the alignment systems AL1, AL2₁-AL2₄ are supplied to the main control apparatus 20 (refer to FIG. 9); furthermore, in FIG. 1, the five alignment systems AL1, AL2₁-AL2₄ and the holding apparatus (i.e., the slider) that hold them are collectively shown as the alignment apparatus 99. Furthermore, the detailed configuration of the alignment apparatus 99 is disclosed in, for example, PCT International Publication No. WO2008/056735.

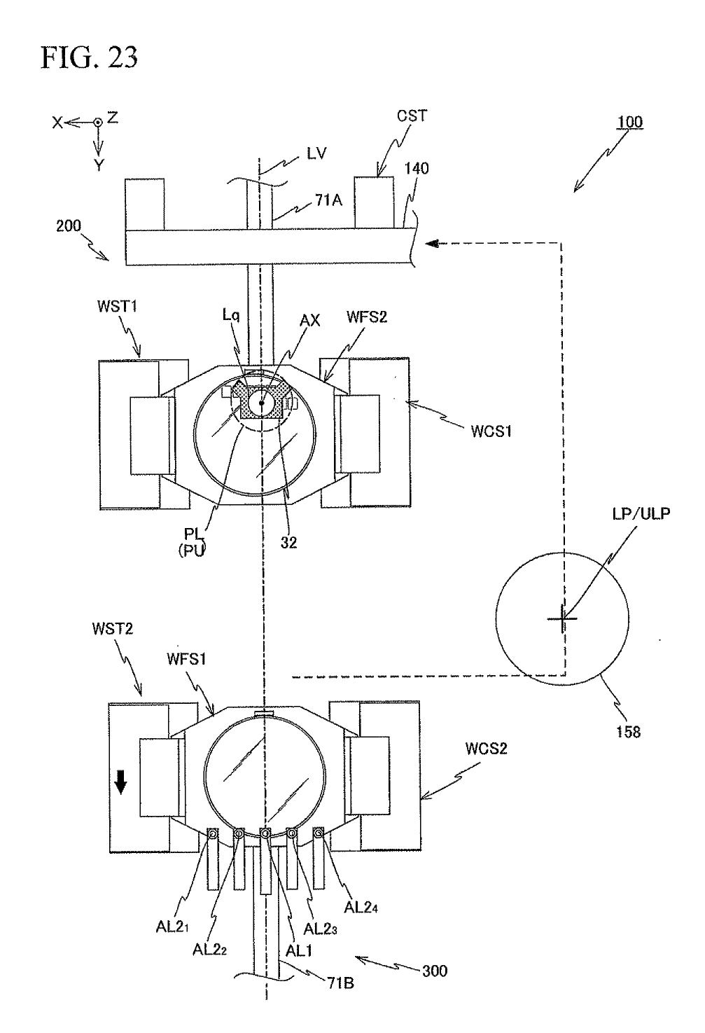

As shown in FIG. 2, the transport stage CST is attached to a tip of a robot arm 140. The robot arm 140 is movable at least within the XY plane. The movement of the robot arm 140 reciprocatively moves (refer to the broken line arrow in FIG. 23) the transport stage CST among the position shown in FIG. 2, namely, a position in the vicinity of a −Y side end part of the exposure station 200, a wafer exchange position, which is indicated by a symbol LP/ULP, and a position on the −Y side of the measurement stage 300. The main control apparatus 20 (refer to FIG. 9) controls the robot arm 140.

The transport stage CST has constituent parts that are identical to the stator parts provided by wafer coarse motion stages (discussed below). Accordingly, for the sake of explanatory convenience, the configuration and the like of the transport stage CST will be explained after the configuration of each constituent part of the stage system that comprises the wafer coarse motion stages has been explained.

A vertically movable table 158 is disposed in the wafer exchange position LP/ULP, as shown in FIG. 2. The main control apparatus 20 (refer to FIG. 9) controls the table 158. The role of the table 158 will be discussed below.

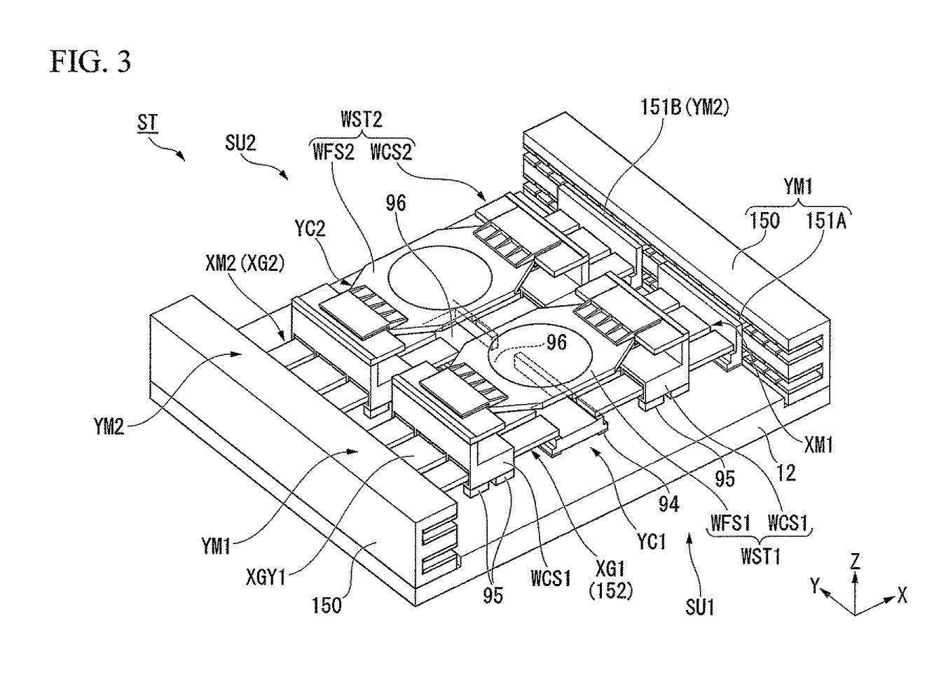

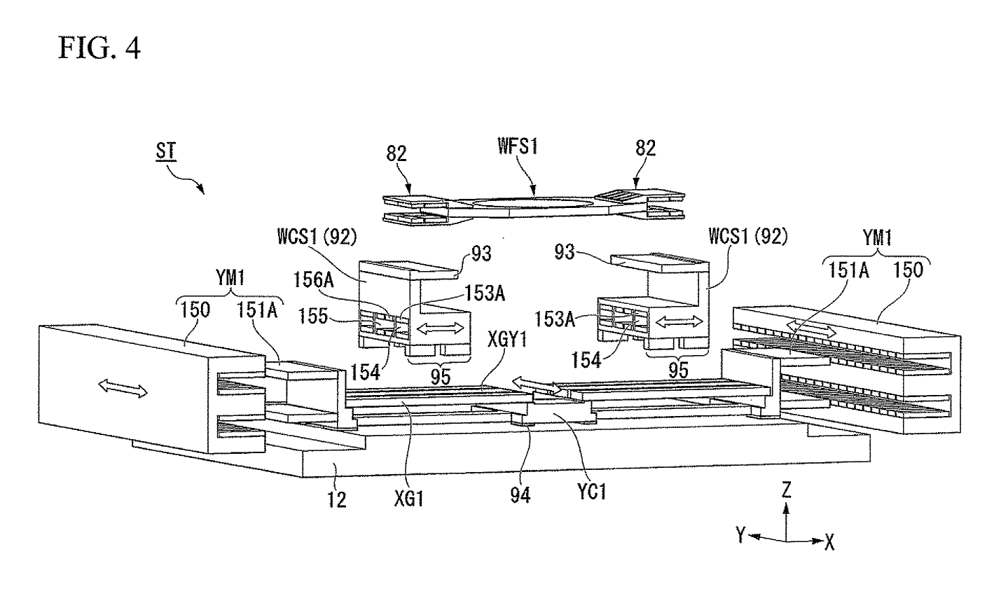

As shown in FIG. 3 and FIG. 4, the stage apparatus ST comprises: a Y coarse motion stage YC1 (i.e., a first moving body), which is driven by Y motors YM1; a Y coarse motion stage YC2 (i.e., another first moving body), which is driven by Y motors YM2; a pair of X coarse motion stages WCS1 (i.e., second moving bodies), which are independently driven by X motors XM1; a pair of X coarse motion stages WCS2 (i.e., other second moving bodies), which are independently driven by X motors XM2; the fine motion stage WFS1, which holds the wafer W and is movably supported by the X coarse motion stages WCS1; and the fine motion stage WFS2, which holds the wafer W and is movably supported by the X coarse motion stages WCS2.

The Y coarse motion stage YC1 and the X coarse motion stages WCS1 constitute a first stage unit SU1, and the Y coarse motion stage YC2 and the X coarse motion stages WCS2 constitute a second stage unit SU2.

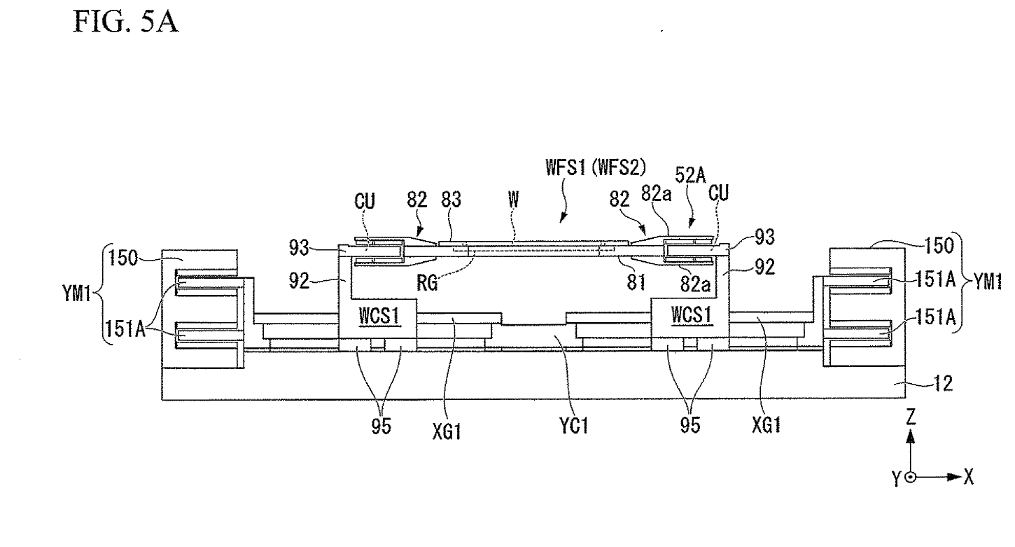

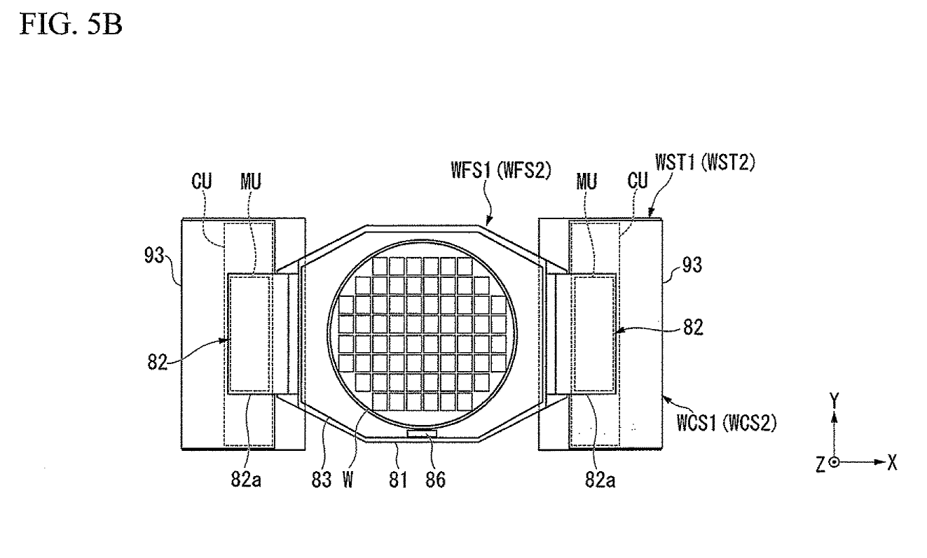

The pair of X coarse motion stages WCS1 and the fine motion stage WFS1 constitute the wafer stage WST1 discussed above. Likewise, the pair of X coarse motion stages WCS2 and the fine motion stage WFS2 constitute the wafer stage WST2 discussed above. The fine motion stages WFS1, WFS2 are driven by fine motion stage drive systems 52A (i.e., drive apparatuses) (refer to FIG. 5A and FIG. 9) in the X, Y, Z, θx, θy, and θz directions, which correspond to six degrees of freedom, with respect to the X coarse motion stages WCS1, WCS2, respectively.

A wafer stage position measuring system 16A measures the position within the XY plane (including the rotation in the θz directions) of the wafer stage WST1 (i.e., the coarse motion stages WCS1). In addition, the fine motion stage position measuring system 70A measures the position of the fine motion stage WFS1 (or the fine motion stage WFS2), which the coarse motion stages WCS1 in the exposure station 200 support, in the directions corresponding to six degrees of freedom (i.e., the X, Y, Z, θx, θy, and θz directions). The measurement results of the wafer stage position measuring system 16A and the fine motion stage position measuring system 70A are supplied to the main control apparatus 20 (refer to FIG. 9) to control the positions of the X coarse motion stages WCS1 and the fine motion stage WFS1 (or WFS2). A wafer stage position measuring system 16B measures the position within the XY plane (including the rotation in the θz directions) of the wafer stage WST2 (i.e., the X coarse motion stages WCS2). In addition, the fine motion stage position measuring system 70B measures the position of the fine motion stage WFS2 (or WFS1), which the X coarse motion stages WCS2 in the measurement station 300 support, in the directions corresponding to six degrees of freedom (i.e., the X, Y, Z, θx, θy, and θz directions). The measurement results of the wafer stage position measuring system 16B and the fine motion stage position measuring system 70B are supplied to the main control apparatus 20 (refer to FIG. 9) to control the positions of the X coarse motion stages WCS2 and the fine motion stage WFS2 (or WFS1).

When the fine motion stage WFS1 (or WFS2) is supported by the X coarse motion stages WCS1, a relative position measuring instrument 22A (refer to FIG. 9), which is provided between the coarse motion stages WCS1 and the fine motion stage WFS1 (or WFS2), can measure the relative position of the fine motion stage WFS1 (or WFS2) and the coarse motion stages WCS1 in the X, Y, and θz directions, which correspond to three degrees of freedom. Likewise, when the fine motion stage WFS2 (or WFS1) is supported by the coarse motion stages WCS2, a relative position measuring instrument 22B (refer to FIG. 9), which is provided between the coarse motion stages WCS2 and the fine motion stage WFS2 (or WFS1), can measure the relative position of the fine motion stage WFS2 (or WFS1) and the coarse motion stages WCS2 in the X, Y, and θz directions, which correspond to three degrees of freedom.

It is possible to use as the relative position measuring instruments 22A, 22B, for example, encoders wherein gratings provided to the fine motion stages WFS1, WFS2 serve as measurement targets, each of the X coarse motion stages WCS1, WCS2 is provided with at least two heads, and the positions of the fine motion stages WFS1, WFS2 in the X axial directions, the Y axial directions, and the θz directions are measured based on the outputs of these heads. The measurement results of the relative position measuring instruments 22A, 22B are supplied to the main control apparatus 20 (refer to FIG. 9).

In addition, in the exposure apparatus 100 of the present embodiment, a pair of image processing type reticle alignment systems RA1, RA2 (in FIG. 1, the reticle alignment system RA2 is hidden on the paper plane far side of the reticle alignment system RA1) is disposed above the reticle stage RST; furthermore, each of the processing type reticle alignment systems RA1, RA2 comprises an image capturing device such as a CCD and uses light (in the present embodiment, the illumination light IL) of the exposure wavelength as the illumination light for alignment, as disclosed in detail in, for example, U.S. Pat. No. 5,646,413. In a state wherein a measuring plate (discussed below) is positioned on the fine motion stage WFS1 (or WFS2) directly below the projection optical system PL, the main control apparatus 20 uses the pair of reticle alignment systems RA1, RA2 to detect, through the projection optical system PL, a pair of first fiducial marks on the measuring plate corresponding to a projected image of a pair of reticle alignment marks (not illustrated) formed on the reticle R; thereby, the positional relationship between the center of the projection area of the pattern of the reticle R formed by the projection optical system PL and the reference position on the measuring plate, namely, the position between the centers of the two first fiducial marks, is detected. The detection signals of the reticle alignment systems RA1, RA2 are supplied to the main control apparatus 20 (refer to FIG. 9) via a signal processing system (not shown).

Next, the configuration of each part of the stage apparatus ST will be discussed in detail.

Furthermore, in FIG. 4, to facilitate understanding, only the configuration of the vicinity of the first stage unit SU1 is illustrated. In addition, because the configuration of the vicinity of the second stage unit SU2 is the same as that of a wafer stage WST1 and its vicinity, the following text explains only the wafer stage WST1.

The Y motors YM1 comprise stators 150, which are provided on both side ends of the base plate 12 in the X directions such that they extend in the Y directions, and sliders 151A, which are provided on both ends of the Y coarse motion stage YC1 in the X directions. The Y motors YM2 comprise the abovementioned stators 150 and sliders 151B, which are provided on both ends of the Y coarse motion stage YC2 in the X directions. Namely, the Y motors YM1, YM2 are configured such that they share the stators 150. The stators 150 comprise permanent magnets, which are arrayed in the Y directions, and the sliders 151A, 151B comprise coils, which are arrayed in the Y directions. Namely, the Y motors YM1, YM2 are moving coil type linear motors that drive both the wafer stages WST1, WST2 and the Y coarse motion stages YC1, YC2 in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stages WST1, WST2, the Y coarse motion stages YC1, YC2, and the like in either one of the Y directions moves the stators 150, which serve as Y countermasses in the Y directions, in the other Y direction and is thereby offset by the law of conservation of momentum.

The Y coarse motion stage YC1 comprises X guides XG1 (i.e., guide members), which are provided between the sliders 151A, 151A and extend in the X directions, and is levitationally supported above the base plate 12 by a plurality of noncontact bearings, for example, air bearings 94, that is provided to a bottom surface of the Y coarse motion stage YC1.

The X guides XG1 are provided with stators 152, which constitute the X motors XM1. As shown in FIG. 4, sliders 153A of the X motors XM1 are provided in through holes 154, wherethrough the X guides XG1 are inserted and that pass through the X coarse motion stages WCS1 in the X directions.

The two X coarse motion stages WCS1 are each levitationally supported above the base plate 12 by a plurality of noncontact bearings, for example, air bearings 95, provided to the bottom surfaces of the X coarse motion stages WCS1 and move in the X directions independently of one another along the X guides XG1 by the drive of the X motors XM1. The Y coarse motion stage YC1 is provided with, in addition to the X guides XG1, X guides XGY1 whereto the stators of the Y linear motors that drive the X coarse motion stages WCS1 in the Y directions are provided. Furthermore, in each of the X coarse motion stages WCS1, a slider 156A of the Y linear motor is provided in a through hole 155 (refer to FIG. 4), which passes through the X coarse motion stages WCS1 in the X directions. Furthermore, a configuration may be adopted wherein the X coarse motion stages WCS1 are supported in the Y directions by providing air bearings instead of providing the Y linear motors.

As shown in FIG. 4, a pair of sidewall parts 92 and a pair of stator parts 93, which are fixed to the upper surfaces of the sidewall parts 92, are provided to the outer side end parts in the X directions of the X coarse motion stages WCS1. As a whole, each of the coarse motion stages WCS1 has a box shape with a small height and that is open at the center part of the upper surface in the X axial directions and both side surfaces in the Y axial directions. Namely, a space is formed in each of the coarse motion stages WCS1 such that the space passes through the inner part of the coarse motion stages WCS1 in the Y axial directions.

As shown in FIG. 4, each stator part 93 of the pair of stator parts 93 comprises a plate shaped member whose outer shape is parallel to the XY plane; furthermore, each of the stator parts 93 houses a coil unit CU, which comprises a plurality of coils for driving the fine motion stage WFS1 (or WFS2). Here, the fine motion stage WFS1 and the fine motion stage WFS2 are identically configured and are similarly supported and driven noncontactually by the coarse motion stages WCS1; therefore, the text below explains the fine motion stage WFS1 only.

As shown in FIG. 5A and FIG. 5B, the fine motion stage WFS1 comprises a main body part 81, which consists of an octagonal plate shaped member whose longitudinal directions are oriented in the X axial directions in a plan view, and two slider parts 82, which are fixed to one end part and the other end part of the main body part 81 in the longitudinal directions.

Because an encoder system measurement beam (i.e., laser light), which is discussed below, must be able to travel through the inner part of the main body part 81, the main body part 81 is formed from a transparent raw material wherethrough light can transmit. In addition, to reduce the effects of air turbulence on the laser light that passes through the inner part of the main body part 81, the main body part 81 is formed as a solid block (i.e., its interior has no space). Furthermore, the transparent raw material preferably has a low coefficient of thermal expansion; in the present embodiment, as one example, synthetic quartz (i.e., glass) is used. Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS1. Furthermore, the wafer holder may be formed integrally with the fine motion stage WFS1 and may be fixed to the main body part 81 by bonding and the like or via, for example, an electrostatic chuck mechanism or a clamp mechanism.

Furthermore, as shown in FIG. 5A and FIG. 5B, a circular opening whose circumference is larger than the wafer W (i.e., the wafer holder) is formed in the center of the upper surface of the main body part 81 on the outer side of the wafer holder (i.e., the mounting area of the wafer W), and a plate 83, whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 5B, an oblong measuring plate 86 that is long and thin in the X axial directions is installed in the −Y side end part of the plate 83 such that the front surface of the measuring plate 86 is substantially coplanar with the front surface of the plate 83, namely, the front surface of the wafer W. At least a pair of the first fiducial marks discussed above and a second fiducial mark, which is detected by the primary alignment system AL1, are formed in the front surface of the measuring plate 86 (note that none of the first and second fiducial marks are shown).

As shown in FIG. 5A, a two-dimensional grating RG (hereinbelow, simply called a “grating”) is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

The upper surface of the grating RG is covered by a protective member, for example, a cover glass (not shown). In the present embodiment, the vacuum chucking mechanism (discussed above), which chucks the wafer holder, is provided to the upper surface of the cover glass, which is a holding surface. Furthermore, in the present embodiment, the cover glass is provided such that it covers substantially the entire surface of the upper surface of the main body part 81, but the cover glass may be provided such that it covers only the part of the upper surface of the main body part 81 that includes the grating RG. In addition, the protective member (i.e., the cover glass) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As is clear from FIG. 5A, the main body part 81 consists, as a whole, of an octagonal plate shaped member wherein overhanging parts that project from the outer sides of both end parts in the longitudinal directions (i.e., the X directions) are formed, and the center area wherein the grating RG is disposed is formed as a plate with a substantially uniform thickness.

Each of the slider parts 82 comprises plate shaped members 82a that are parallel to the XY plane and that are positioned on both sides of the corresponding stator part 93 in the Z directions such that they sandwich the stator part 93. An end part of a stator part 93 of each of the coarse motion stages WCS1 is noncontactually inserted between the corresponding two plate shaped members 82a, 82a. In addition, each of the plate shaped members 82a houses a magnet unit MU, which is discussed below.

Here, as discussed above, both side surfaces of each of the coarse motion stages WCS1 in the Y axial directions are open; therefore, when the fine motion stage WFS1 is mounted to the coarse motion stages WCS1, the fine motion stage WFS1 should be positioned in the Z axial directions such that each of the stator parts 93 are positioned between the two corresponding plate shaped members 82a, 82a; subsequently, the fine motion stage WFS1 should be moved (i.e., slid) in the Y axial directions.

Each of the fine motion stage drive systems 52A comprises a pair of the magnet units MU, which is provided to the corresponding slider part 82 discussed above, and one of the coil units CU, which is provided to the corresponding stator part 93.

This will now be discussed in more detail. Although not shown, a coil array, wherein YZ coils that are oblong in a plan view are disposed equispaced in the Y axial directions, and one X coil that is a long, thin oblong in a plan view and whose longitudinal directions are oriented in the Y axial directions are disposed with a prescribed spacing in the X axial directions inside each of the stator parts 93, and these coils constitute one of the coil units CU.

A magnet array, wherein the magnets are disposed corresponding to the array of the abovementioned coils and wherein the permanent magnets are disposed equispaced in the Y axial directions, and a pair of permanent magnets (i.e., two), whose longitudinal directions are oriented in the Y axial directions, are disposed inside of each of the plate shaped members 82a that constitute part of the slider parts 82 of the fine motion stage WFS1.

The permanent magnets that constitute the magnet arrays are arrayed such that their directions of polarity alternate. In addition, the two permanent magnets are disposed such that their polarities are the opposite of one another. The magnet array and the pair of permanent magnets constitute the magnet unit MU. Furthermore, another of the slider parts 82 and another of the stator parts 93, which are similarly configured, are disposed as a set on the other end in the X directions of the fine motion stage WFS1 also.

Because the present embodiment adopts the arrangement of the coils and permanent magnets as discussed above, the main control apparatus 20 can drive the fine motion stage WFS1 in the Y axial directions by supplying an electric current to every other coil of the plurality of the YZ coils arrayed in the Y axial directions. In addition, in parallel therewith, the main control apparatus 20 can levitate the fine motion stage WFS1 above the coarse motion stages WCS1 by generating driving forces in the Z axial directions that are separate from the driving forces in the Y axial directions by supplying electric currents to coils of the YZ coils that are not used to drive the fine motion stage WFS1 in the Y axial directions. Furthermore, by sequentially switching, in accordance with the position of the fine motion stage WFS1 in the Y axial directions, which of the coils are supplied with electric current, the main control apparatus 20 drives the fine motion stage WFS1 in the Y axial directions while maintaining the state wherein the fine motion stage WFS1 is levitated above the coarse motion stages WCS1, namely, a noncontactual state. In addition, in the state wherein the fine motion stage WFS1 is levitated above the coarse motion stages WCS1, the main control apparatus 20 can also drive the fine motion stage WFS1 independently in the X axial directions in addition to the Y axial directions.

As can be understood from the explanation above, in the present embodiment, the fine motion stage drive system 52A can levitationally support the fine motion stage WFS1 in a noncontactual state above the coarse motion stages WCS1 and can drive the coarse motion stages WCS1 noncontactually in the X, Y, and Z axial directions. In addition, the main control apparatus 20 can rotate the fine motion stage WFS1 around the Z axis (i.e., can perform θz rotation) by causing driving forces (i.e., thrusts) of different magnitudes in the Y axial directions to act on the slider parts 82 on both ends of the fine motion stage WFS1. In addition, the main control apparatus 20 can rotate the fine motion stage WFS1 around the Y axis (i.e., can perform θy drive to rotation) by causing different levitational forces to act on the slider parts 82 on both ends of the fine motion stage WFS1 in the X directions. Furthermore, the main control apparatus 20 can rotate the fine motion stage WFS1 around the X axis (i.e., can perform θx drive to rotation) by causing levitational forces of different magnitudes to act on the plus side and the minus side in the Y axial directions of, for example, each of the slider parts 82 on both ends of the fine motion stage WFS1 in the X directions.

As discussed above, in the present embodiment, the fine motion stage drive system 52A levitationally supports the fine motion stage WFS1 on the coarse motion stages WCS1 in a noncontactual state and can drive the coarse motion stages WCS1 noncontactually in the directions corresponding to six degrees of freedom.

In the exposure apparatus 100 of the present embodiment, when a step-and-scan type exposure operation is being performed on the wafer W, the main control apparatus 20 uses an encoder system 73 (refer to FIG. 9) of the fine motion stage position measuring system 70A (discussed below) to measure the position within the XY plane (including the position in the θz directions) of the fine motion stage WFS1. The positional information of the fine motion stage WFS1 is sent to the main control apparatus 20, which, based thereon, controls the position of the fine motion stage WFS1.

In contrast, when the wafer stage WST1 (i.e., the fine motion stage WFS1) is positioned outside of the measurement area of the fine motion stage position measuring system 70A, the main control apparatus 20 uses the wafer stage position measuring system 16A (refer to FIG. 1 and FIG. 9) to measure the position of the wafer stage WST1 (and the fine motion stage WFS1). As shown in FIG. 1, the wafer stage position measuring system 16A comprises laser interferometers, which radiate length measuring beams to reflective surfaces on the side surfaces of the coarse motion stages WCS1 and measure the position within the XY plane (including the rotation in the θz directions) of the wafer stage WST1. Further more, instead of using the wafer stage position measuring system 16A discussed above to measure the position within the XY plane of the wafer stage WST1, some other measuring apparatus, for example, an encoder system, may be used. In such a case, for example, a two dimensional scale can be disposed on the upper surface of the base plate 12, and an encoder head can be provided to each of the bottom surfaces of the coarse motion stages WCS1.

The fine motion stage WFS2 is configured identically to the fine motion stage WFS1 discussed above; furthermore, the coarse motion stages WCS1 can noncontactually support the fine motion stage WFS2 instead of the fine motion stage WFS1. In such a case, the wafer stage WST1 would comprise the coarse motion stages WCS1 and the fine motion stage WFS2 supported by the coarse motion stages WCS1, and the fine motion stage drive system 52A would comprise the pairs of slider parts (i.e., the pairs of magnet units MU) provided by the fine motion stage WFS2 and the pair of stator parts 93 (i.e., the coil units CU) of the coarse motion stages WCS1. Furthermore, the fine motion stage drive system 52A would drive the fine motion stage WFS2 noncontactually with respect to the coarse motion stages WCS1 in the directions corresponding to six degrees of freedom.

In addition, each of the fine motion stages WFS2, WFS1 can be supported noncontactually by the coarse motion stages WCS2; furthermore, the wafer stage WST2 comprises the coarse motion stages WCS2 and the fine motion stage WFS2 or WFS1 supported by the coarse motion stages WCS2. In this case, a fine motion stage drive system 52B (refer to FIG. 9) would comprise the pairs of slider parts (i.e., the pairs of magnet units MU) provided by the fine motion stage WFS2 or WFS1 and the pair of stator parts 93 (i.e., the coil units CU) of the coarse motion stages WCS2. Furthermore, the fine motion stage drive system 52B would drive the fine motion stage WFS2 or WFS1 noncontactually with respect to the coarse motion stages WCS2 in the directions corresponding to six degrees of freedom.

The following text explains the configuration of the fine motion stage position measuring system 70A (refer to FIG. 9), which is used to measure the position of the fine motion stage WFS1 or WFS2 (which constitutes the wafer stage WST1) held movably by the coarse motion stages WCS1 in the exposure station 200. Here, the case wherein the fine motion stage position measuring system 70A measures the position of the fine motion stage WFS1 will be explained.

As shown in FIG. 1, the fine motion stage position measuring system 70A comprises the measuring arm 71A, which is inserted in the space inside each of the coarse motion stages WCS1 in the state wherein the wafer stage WST1 is disposed below the projection optical system PL. The measuring arm 71A is supported in a cantilevered state by the main frame BD via the support member 72A (i.e., the vicinity of one-end part is supported).

The measuring arm 71A is a square columnar shaped member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71A is formed from the identical raw material wherethrough the light transmits, for example, by laminating a plurality of glass members together. The measuring arm 71A is formed as a solid, excepting the portion wherein the encoder head (i.e., the optical system) is housed (discussed below). As discussed above, a tip part of the measuring arm 71A is inserted in the spaces of the coarse motion stages WCS1 in the state wherein the wafer stage WST1 is disposed below the projection optical system PL; furthermore, as shown in FIG. 1, the upper surface of the measuring arm 71A opposes the lower surface of the fine motion stage WFS1 (more accurately, the lower surface of the main body part 81; not shown in FIG. 1; refer to FIG. 5A and the like). The upper surface of the measuring arm 71A is disposed substantially parallel to the lower surface of the fine motion stage WFS1 in the state wherein a prescribed clearance, for example, approximately several millimeters, is formed between the upper surface of the measuring arm 71A and the lower surface of the fine motion stage WFS1.

As shown in FIG. 9, the fine motion stage position measuring system 70A comprises the encoder system 73 and a laser interferometer system 75. The encoder system 73 comprises an X linear encoder 73x, which measures the position of the fine motion stage WFS1 in the X axial directions, and a pair of Y linear encoders 73ya, 73yb, which measures the position of the fine motion stage WFS1 in the Y axial directions. The encoder system 73 uses diffraction interference type heads with a configuration identical to that of the encoder head (herein below, abbreviated as “head” where appropriate) disclosed in, for example, U.S. Pat. No. 7,238,931 and U.S. Patent Application Publication No. 2007/288121. However, in the head of the present embodiment, the light source and a light receiving system (including a photodetector) are disposed outside of the measuring arm 71A (as discussed below), and only the optical system is disposed inside the measuring arm 71A, namely, opposing the grating RG. Herein below, the optical system disposed inside the measuring arm 71A is called a head where appropriate.

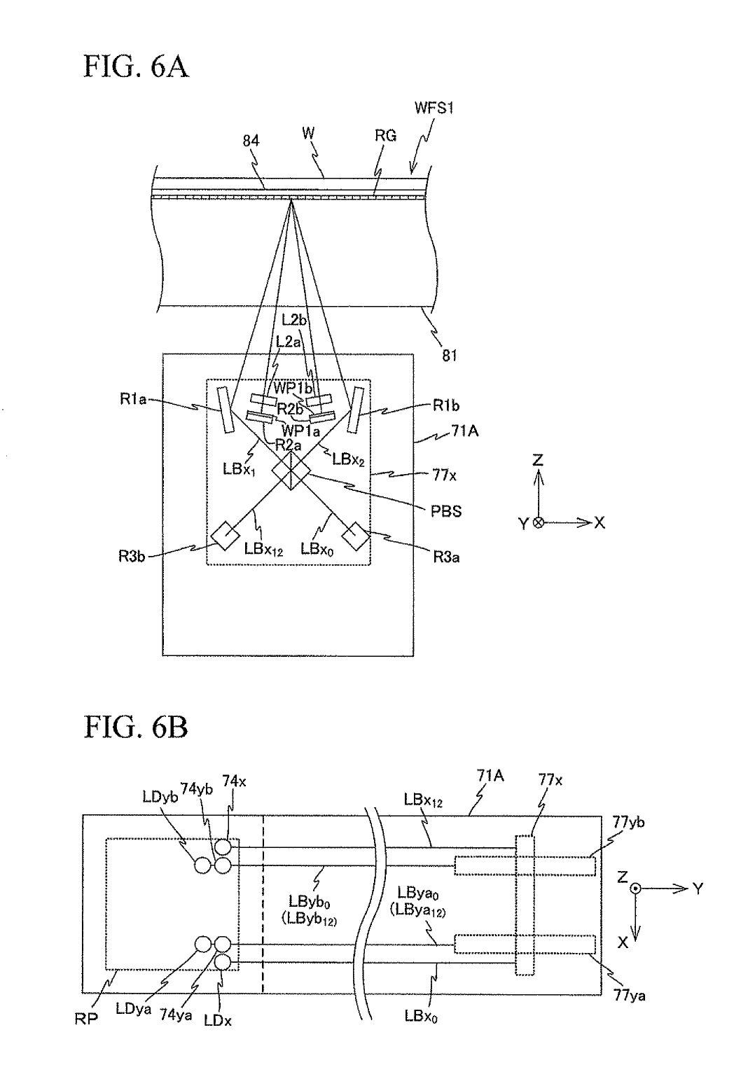

The encoder system 73 uses one X head 77x (refer to FIG. 6A and FIG. 6B) to measure the position of the fine motion stage WFS1 in the X axial directions, and uses a pair of Y heads 77ya, 77yb (refer to FIG. 6B) to measure the position of the fine motion stage WFS1 in the Y axial directions. Namely, the X linear encoder 73x (discussed above) comprises the X head 77x that uses the X diffraction grating of the grating RG to measure the position of the fine motion stage WFS1 in the X axial directions, and the pair of Y linear encoders 73ya, 73yb comprises the pair of Y heads 77ya, 77yb that uses the Y diffraction grating of the grating RG to measure the position of the fine motion stage WFS1 in the Y axial directions.

Here, the configuration of the three heads 77x, 77ya, 77yb that constitute the encoder system 73 will be explained. FIG. 6A shows a schematic configuration of the X head 77x, which represents all three of the heads 77x, 77ya, 77yb. In addition, FIG. 6B shows the arrangement of the X head 77x and the Y heads 77ya, 77yb inside the measuring arm 71A.

As shown in FIG. 6A, the X head 77x comprises a polarizing beam splitter PBS, a pair of reflective mirrors R1a, R1b, a pair of lenses L2a, L2b, a pair of quarter wave plates WP1a, WP1b (hereinbelow, denoted as λ/4 plates), a pair of reflective mirrors R2a, R2b, and a pair of reflective mirrors R1a, R3b; furthermore, these optical elements are disposed with prescribed positional relationships. The optical systems of the Y heads 77ya, 77yb also have the same configuration. As shown in FIG. 6A and FIG. 6B, the X head 77x and the Y heads 77ya, 77yb are each unitized and fixed inside the measuring arm 71A.

As shown in FIG. 6B, in the X head 77x (i.e., the X linear encoder 73x), a light source LDx, which is provided to the upper surface of the −Y side end part of the measuring arm 71A (or there above), emits in the −Z direction a laser beam LBx₀, the laser beam LBx₀ transits a reflective surface RP, which is provided to part of the measuring arm 71A such that the reflective surface RP is tilted at a 45° angle with respect to the XY plane, and the optical path of the laser beam LBx₀ is thereby folded in a direction parallel to the Y axial directions. The laser beam LBx₀ advances parallel to the Y axial directions through the solid portion inside the measuring arm 71A and reaches the reflective mirror R3a (refer to FIG. 6A). Furthermore, the reflective mirror R3a folds the optical path of the laser beam LBx₀, and the laser beam LBx₀ thereby impinges the polarizing beam splitter PBS. The polarizing beam splitter PBS polarizes and splits the laser beam LBx₀, which becomes two measurement beams LBx₁, LBx₂. The measurement beam LBx₁, which transmits through the polarizing beam splitter PBS, reaches the grating RG, which is formed in the fine motion stage WFS1, via the reflective mirror R1a; furthermore, the measurement beam LBx₂, which is reflected by the polarizing beam splitter PBS, reaches the grating RG via the reflective mirror R1b. Furthermore, “polarization splitting” herein means the splitting of the incident beam into a P polarized light component and an S polarized light component.

Diffraction beams of a prescribed order (e.g., first order diffraction beams), which are generated by the grating RG as a result of the radiation of the beams LBx₁, LBx₂, transit the lenses L2a, L2b, are converted to circularly polarized beams by the λ/4 plates WP1a, WP1b, are subsequently reflected by the reflective mirrors R2a, R2b, pass once again through the λ/4 plates WP1a, WP1b, and reach the polarizing beam splitter PBS by tracing the same optical path as the forward path, only in reverse.

The polarized directions of each of the two first order diffraction beams that reach the polarizing beam splitter PBS are rotated by 90° with respect to the original directions. Consequently, the first order diffraction beams of the measurement beams LBx₁, LBx₂ are combined coaxially as a combined beam LBx₁₂. The reflective mirror R3b folds the optical path of the combined beam LBx₁₂ such that it is parallel to the Y axis, after which the combined beam LBx₁₂ travels parallel to the Y axis inside the measuring arm 71A, transits the reflective surface RP (discussed above), and is sent to an X light receiving system 74x, which is provided to the upper surface of the −Y side end part of the measuring arm 71A (or there above), as shown in FIG. 6B.

In the X light receiving system 74x, the first order diffraction beams of the measurement beams LBx₁, LBx₂, which were combined into the combined beam LBx₁₂, are aligned in polarization directions by a polarizer (i.e., an analyzer), which is not shown, and therefore interfere with one another to form an interfered beam, which is detected by the photodetector (not shown) and then converted to an electrical signal that corresponds to the intensity of the interfered beam. Here, when the fine motion stage WFS1 moves in either of the measurement directions (in this case, the X axial directions), the phase difference between the two beams changes, and thereby the intensity of the interfered beam changes. These changes in the intensity of the interfered beam are supplied to the main control apparatus 20 (refer to FIG. 9) as the positional information in the X axial directions of the fine motion stage WFS1.

As shown in FIG. 6B, laser beams LBya₀, LByb₀ are emitted from light sources LDya, LDyb and the reflective surface RP (discussed above) folds the optical paths of the laser beams LBya₀, LByb₀ by 90°, after which the laser beams LBya₀, LByb₀ are parallel to the Y axis and enter into the Y heads 77ya, 77yb. Combined beams LBya₁₂, LByb₁₂ of the first order diffraction beams, which have been polarized and split by the polarizing beam splitters and the grating RG (i.e., the Y diffraction grating) as discussed above, are output from the Y heads 77ya, 77yb, and return to Y light receiving systems 74ya, 74yb. Here, the laser beams LBya₀, LByb₀, which were emitted from the light sources LDya, LDyb, and the combined beams LBya₁₂, LByb₁₂, which return to the Y light receiving systems 74ya, 74yb, travel with overlapping optical paths in the directions perpendicular to the paper plane in FIG. 6B. In addition, as discussed above, inside the Y heads 77ya, 77yb, the optical paths of the laser beams LBya₀, LByb₀ radiated from the light sources LDya, LDyb and the optical paths of the combined beams LBya₁₂, LByb₁₂ that return to the Y light receiving systems 74ya, 74yb are folded as appropriate (not shown) such that those optical paths are parallel and spaced apart in the Z axial directions.

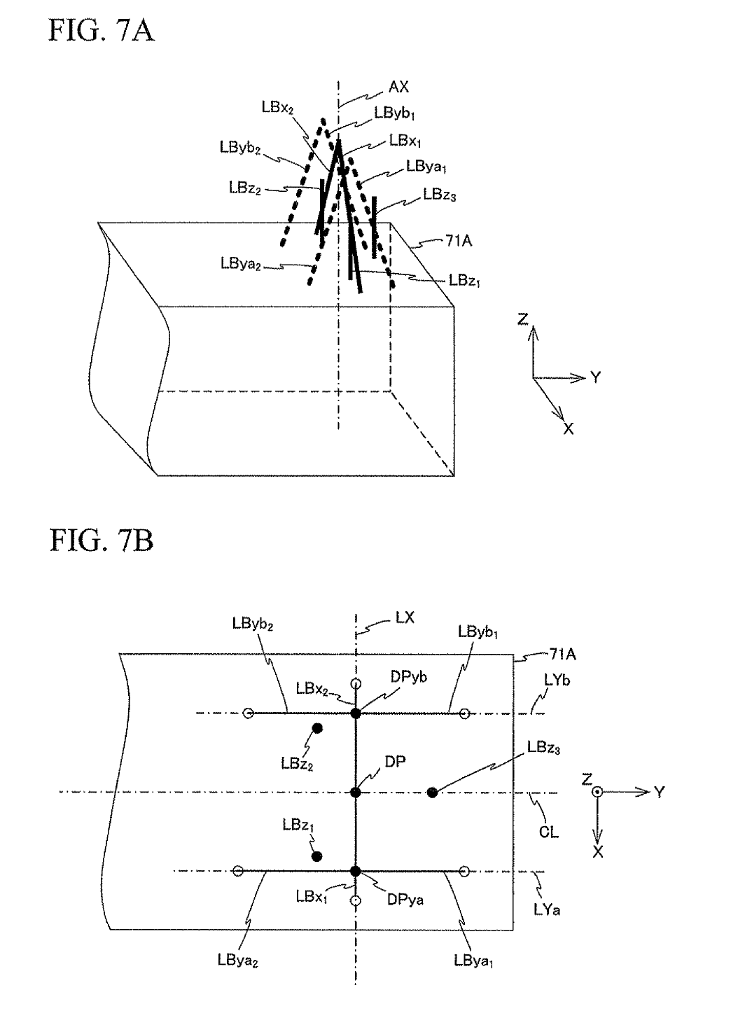

FIG. 7A is an oblique view of the tip part of the measuring arm 71A, and FIG. 7B is a plan view, viewed from the +Z direction, of the upper surface of the tip part of the measuring arm 71A. As shown in FIG. 7A and FIG. 7B, the X head 77x radiates the measurement beams LBx₁, LBx₂ (indicated by solid lines in FIG. 7A) from two points (refer to the white circles in FIG. 7B), which are equidistant from a centerline CL of the measuring arm 71A along a straight line LX parallel to the X axis, to the identical irradiation point on the grating RG (refer to FIG. 6A). The irradiation point of the measurement beams LBx₁, LBx₂, namely, the detection point of the X head 77x (refer to symbol DP in FIG. 7B) coincides with the exposure position (refer to FIG. 1), which is the center of the irradiation area IA (i.e., the exposure area) of the illumination light IL radiated to the wafer W. Furthermore, although the measurement beams LBx₁, LBx₂ are in actuality refracted by for example, the interface surface between the main body part 81 and the air layer, this aspect is shown in a simplified form in FIG. 6A and the like.

As shown in FIG. 6B, the two Y heads 77ya, 77yb are disposed on opposite sides of the centerline CL, one on the +X side and one on the −X side. As shown in FIG. 7A and FIG. 7B, the Y head 77ya radiates measurement beams LBya₁, LBya₂, which are indicated by broken lines in FIG. 7A, from two points (refer to the white circles in FIG. 7B), which are equidistant from the straight line LX along a straight line LYa, to a common irradiation point on the grating RG. The irradiation point of the measurement beams LBya₁, LBya₂, namely, the detection point of the Y head 77ya, is indicated by a symbol DPya in FIG. 7B.

The Y head 77yb radiates measurement beams LByb₁, LByb₂ from two points (refer to the white circles in FIG. 7B), which are symmetric to the emitting points of the measurement beams LBya₁, LBya₂ of the Y head 77ya with respect to the centerline CL, to a common irradiation point DPyb on the grating RG. As shown in FIG. 7B, the detection points DPya, DPyb of the Y heads 77ya, 77yb are disposed along the straight line LX, which is parallel to the X axis.

Here, the main control apparatus 20 determines the position of the fine motion stage WFS1 in the Y axial directions based on the average of the measurement values of the two Y heads 77ya, 77yb. Accordingly, in the present embodiment, the position of the fine motion stage WFS1 in the Y axial directions is measured such that the midpoint DP of the detection points DPya, DPyb substantially serves as the measurement point. The midpoint DP coincides with the irradiation point of the measurement beams LBx₁, LBx₂ on the grating RG.

Namely, in the present embodiment, the positional measurements of the fine motion stage WFS1 in the X axial directions and the Y axial directions have a common detection point and this detection point coincides with the exposure position, which is the center of the irradiation area IA (i.e., the exposure area) of the illumination light IL radiated to the wafer W. Accordingly, in the present embodiment, the main control apparatus 20 uses the encoder system 73 to continuously measure—directly below the exposure position (i.e., on the rear surface side of the fine motion stage WFS1)—the position of the fine motion stage WFS1 within the XY plane when the pattern of the reticle R is transferred to a prescribed shot region on the wafer W mounted on the fine motion stage WFS1. In addition, the main control apparatus 20 measures the amount of rotation of the fine motion stage WFS1 in the θz directions based on the difference in the measurement values of the two Y heads 77ya, 77yb.

As shown in FIG. 7A, in the laser interferometer system 75, three length measuring beams LBz₁, LBz₂, LBz₃ emerge from the tip part of the measuring arm 71A and impinge the lower surface of the fine motion stage WFS1. The laser interferometer system 75 comprises three laser interferometers 75a-75c (refer to FIG. 9), each of which radiates one of these three length measuring beams LBz₁, LBz₂, LBz₃.

As shown in FIG. 7A and FIG. 7B, in the laser interferometer system 75, the center of gravity of the three length measuring beams LBz₁, LBz₂, LBz₃ coincides with the exposure position, which is the center of the irradiation area IA (i.e., the exposure area), and the length measuring beams LBz₁, LBz₂, LBz₃ are emitted parallel to the Z axis from three points that correspond to the vertices of an isosceles triangle (or a regular triangle). In this case, the emitting point (i.e., the irradiation point) of the length measuring beam LBz₃ is positioned along the centerline CL, and the emitting points (i.e., the irradiation points) of the remaining length measuring beams LBz₁, LBz₂ are equidistant from the centerline CL. In the present embodiment, the main control apparatus 20 uses the laser interferometer system 75 to measure the position in the Z axial directions and the amounts of rotation in the θz and θy directions of the fine motion stage WFS1. Furthermore, the laser interferometers 75a-75c are provided to the upper surface of the −Y side end part of the measuring arm 71A (or there above). The length measuring beams LBz₁, LBz₂, LBz₃, which are emitted in the −Z direction from the laser interferometers 75a-75c transit the reflective surface RP (discussed above), travel along the Y axial directions inside the measuring arm 71A, wherein their optical paths are folded, and emerge from the three points discussed above.

In the present embodiment, a wavelength selecting filter (not shown), which transmits the measurement beams from the encoder system 73 but hinders the transmission of the length measuring beams from the laser interferometer system 75, is provided to the lower surface of the fine motion stage WFS1. In this case, the wavelength selecting filter serves double duty as the reflective surface of the length measuring beams from the laser interferometer system 75.

As can be understood from the explanation above, using the encoder system 73 of the fine motion stage position measuring system 70A and the laser interferometer system 75, the main control apparatus 20 can measure the position of the fine motion stage WFS1 in directions corresponding to six degrees of freedom. In this case, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS1 within the XY plane (including the θz directions). In addition, because the detection point of the encoder system 73 on the grating RG in the X axial directions and in the Y axial directions and the detection point of the laser interferometer system 75 on the lower surface of the fine motion stage WFS1 in the Z axial directions substantially coincide with the center (i.e., the exposure position) of the exposure area IA, so-called Abbé error is suppressed to such a degree that it is substantially inconsequential. Accordingly, using the fine motion stage position measuring system 70A, the main control apparatus 20 can measure, with high accuracy, the position of the fine motion stage WFS1 in the X axial directions, the Y axial directions, and the Z axial directions without Abbé error. In addition, if the coarse motion stages WCS1 are disposed below the projection unit PU and the fine motion stage WFS2 is movably supported by the coarse motion stages WCS1, then, using the fine motion stage position measuring system 70A, the main control apparatus 20 can measure the position of the fine motion stage WFS2 in the directions corresponding to six degrees of freedom; in particular, the main control apparatus 20 can measure, with high accuracy and without Abbé error, the position of the fine motion stage WFS2 in the X axial directions, the Y axial directions, and the Z axial directions.

In addition, as shown in FIG. 1, the fine motion stage position measuring system 70B, which is provided to the measurement station 300, is bilaterally symmetric with and identically configured to the fine motion stage position measuring system 70A. Accordingly, the measuring arm 71B, which is provided to the fine motion stage position measuring system 70B, is oriented such that its longitudinal directions are in the Y axial directions; furthermore, the vicinity of the +Y side end part of the measuring arm 71B is supported such that it is substantially cantilevered from the main frame BD via the support member 72B.

If the coarse motion stages WCS2 are disposed below the alignment apparatus 99 and the fine motion stage WFS2 or WFS1 is movably supported by the coarse motion stages WCS2, then, using the fine motion stage position measuring system 70B, the main control apparatus 20 can measure the position of the fine motion stage WFS2 or WFS1 in the directions corresponding to six degrees of freedom; in particular, the main control apparatus 20 can measure, with high accuracy and without Abbé error, the position of the fine motion stage WFS2 or WFS1 in the X axial directions, the Y axial directions, and the Z axial directions.

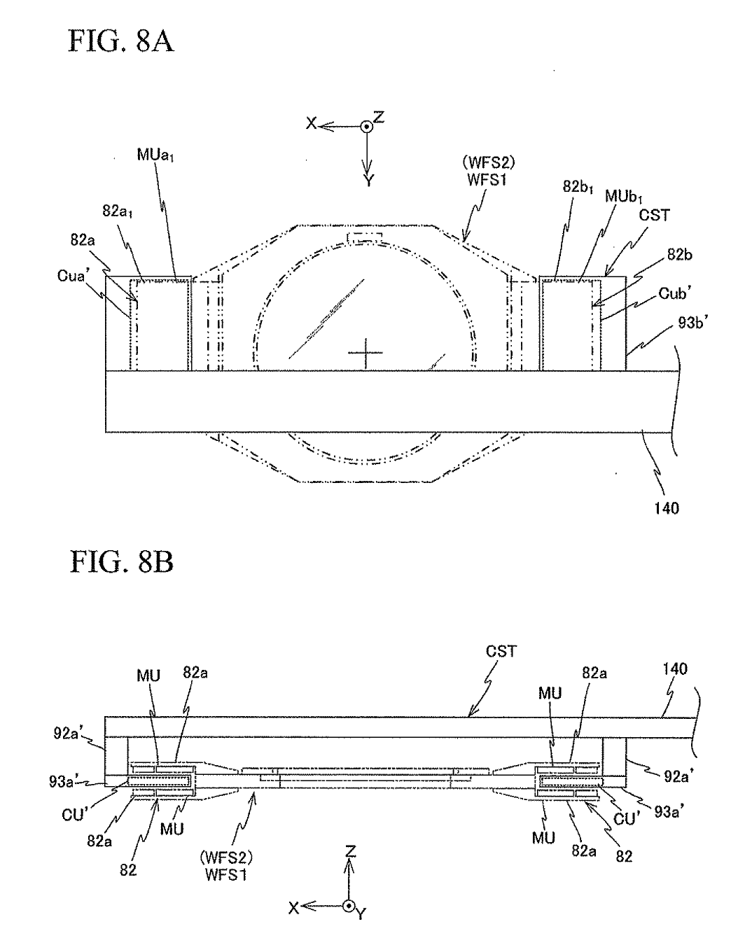

The configuration of the transport stage CST will now be explained. FIG. 8A is a plan view of the transport stage CST, and FIG. 8B is a side view, viewed from the +Y direction, of the transport stage CST. Here, in FIG. 8A and FIG. 8B, the fine motion stages WFS1 (WFS2) are both illustrated using virtual lines (i.e., chain double dashed lines).

As can be understood from FIG. 8A and FIG. 8B, the transport stage CST comprises: two support members 92a′, which are oblong plate shaped members that are fixed to the lower surface of the tip part of the robot arm 140 such that they are spaced apart in the X axial directions by the same spacing as the two sidewall parts 92 discussed above; and two stator parts 93a′, the +Y side end parts of which are fixed to the lower surfaces of the support members 92a′. As shown in FIG. 8B, the tip part of the robot arm 140 also serves as a coupling part that couples with the pair of support members 92a′. Accordingly, the following text explains the configuration of the transport stage CST—including the coupling part 92a′.

Although each of the two stator parts 93a′ is somewhat shorter than the stator parts 93 discussed above, the stator parts 93a′ are configured identically to the stator parts 93. Namely, each of the stator parts 93a′ is a member whose external shape is plate shaped and that houses a coil unit CU′.

Here, as can also be understood from FIG. 8B, because the transport stage CST is configured as discussed above, the transport stage CST is first positioned with respect to the fine motion stage WFS1 (or WFS2) such that the stator parts 93a′ are positioned in the gaps in the Z directions formed by the plate shaped members 82a on both ends of the fine motion stage WFS1 (or WFS2) in the X directions; subsequently, if the fine motion stage WFS1 (or WFS2) is moved (i.e., slid) in the Y axial directions, then the fine motion stage WFS1 (or WFS2) can be supported by the transport stage CST. In the present embodiment, the transport stage CST is normally maintained at a height at which it can be positioned with respect to the fine motion stage WFS1 (or WFS2).

The coil units CU′, which are provided to each of the stator parts 93a′, and the magnet units MU, which are provided to each of the slider parts 82, constitute the linear motors, which drive the slider parts 82 in at least the Y axial directions and are disposed on both ends of the fine motion stage WFS1 in the X directions. Furthermore, the two (i.e., the pair of) linear motors constitute a fine motion stage drive system 52C (refer to FIG. 9), which drives the fine motion stage WFS1 (or WFS2) with respect to the transport stage CST by sliding the fine motion stage WFS1 (or WFS2) in at least the Y axial directions.

FIG. 9 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 including the local liquid immersion apparatus 8, coarse motion stage drive systems 51A, 51B, and the fine motion stage drive systems 52A, 52B, 52C, which are discussed above.

When a device is fabricated using the exposure apparatus 100 of the present embodiment, the pattern of the reticle R is transferred to each shot region of the plurality of shot regions on the wafer W by performing a step-and-scan type exposure on the wafer W, which is held by one of the fine motion stages (here, the WFS1 as an example) held by the coarse motion stages WCS1 in the exposure station 200. In the step-and-scan type exposure operation, the main control apparatus 20 repetitively performs an inter-shot movement operation, wherein the fine motion stage WFS1 is moved to a scanning start position (i.e., an acceleration start position) in order to expose each of the shot regions on the wafer W, and a scanning exposure operation, wherein the pattern formed on the reticle R is transferred to each of the shot regions by a scanning exposure, based on, for example, the result of the wafer alignment (e.g., the information obtained by converting the array coordinates of each shot region on the wafer W obtained by enhanced global alignment (EGA) to coordinates wherein the second fiducial mark serves as a reference) and the result of the reticle alignment, both alignments being performed in advance. Furthermore, the abovementioned exposure operation is performed in the state wherein the liquid Lq is held between the tip lens 191 and the wafer W, namely, the abovementioned exposure operation is performed by an immersion exposure. In addition, the operation is performed in order starting with the shot regions positioned on the −Y side and ending with the shot regions positioned on the +Y side. Furthermore, EGA is disclosed in detail in, for example, U.S. Pat. No. 4,780,617.

In the exposure apparatus 100 of the present embodiment, during the sequence of exposure operations discussed above, the main control apparatus 20 uses the fine motion stage position measuring system 70A to measure the position of the fine motion stage WFS1 (i.e., the wafer W) and, based on this measurement result, controls the position of the wafer W.

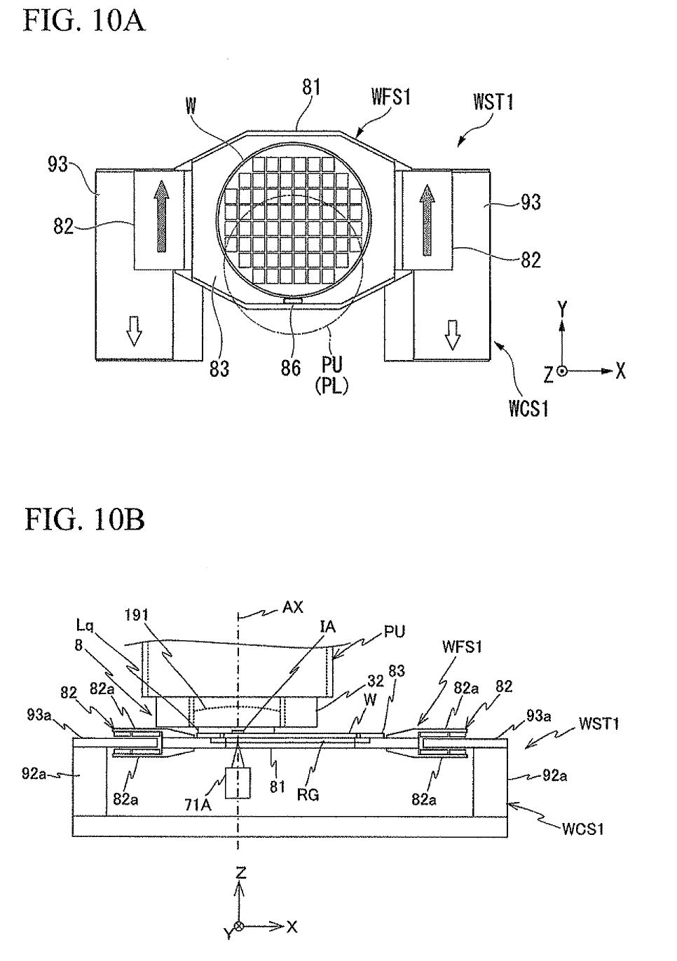

Furthermore, during the scanning exposure operation discussed above, the wafer W must be driven in the Y axial directions at a high acceleration; however, in the exposure apparatus 100 of the present embodiment, as shown in FIG. 10A, the main control apparatus 20 scans the wafer W in the Y axial directions by driving only the fine motion stage WFS1 in the Y axial directions (refer to the solid arrows in FIG. 10A; and, as needed, in the directions corresponding to the other five degrees of freedom) without, as a rule, driving the coarse motion stages WCS1. This is because to drive the wafer W at a high acceleration, it is advantageous to drive the wafer W using only the fine motion stage WFS1, which is lighter than the coarse motion stages WCS1. In addition, as discussed above, the position measurement accuracy of the fine motion stage position measuring system 70A is higher than that of the wafer stage position measuring system 16A, and therefore it is advantageous to drive the fine motion stage WFS1 during the scanning exposure. Furthermore, during the scanning exposure, the action of the reaction force (refer to the outlined arrows in FIG. 10(A)) generated by the drive of the fine motion stage WFS1 drives the coarse motion stages WCS1 in a direction opposite that of the fine motion stage WFS1. Namely, the coarse motion stages WCS1 function as countermasses and conserve the momentum of the system that constitutes the entire wafer stage WST1, and thereby the center of gravity does not move; therefore, the problem wherein, for example, a bias load acts on the base plate 12 owing to the drive of the fine motion stage WFS1 during a scan does not arise.

Moreover, when the inter-shot movement operation (i.e., stepping) is performed in the X axial directions, the fine motion stage WFS1 can move in the X axial directions by only a small amount; therefore, as shown in FIG. 10B, the main control apparatus 20 moves the wafer W in the X axial directions by driving the coarse motion stages WCS1 in the X axial directions.

In the present embodiment, while one of the wafers W is being exposed on one of the fine motion stages as discussed above, another is being at least partly exchanged or aligned on the other fine motion stage in parallel with the exposure.

### (Parallel Process Operations)

The following text explains the parallel process operations performed using the two fine motion stages WFS1, WFS2 in the exposure apparatus 100 of the present embodiment.

FIG. 2 shows a state during which the fine motion stage WFS1 is at the exposure station 200 and the exposure discussed above is being performed on one of the wafers W, which is held by the fine motion stage WFS1; furthermore, the fine motion stage WFS2 is at the measurement station 300 where another wafer W, which is held by the fine motion stage WFS2, is being aligned. At this time, the transport stage CST stands by at the standby position in the vicinity of the support member 72A (i.e., above the measuring arm 71A).

The following text briefly describes how the main control apparatus aligns the wafer W held by the fine motion stage WFS2.

Namely, when a wafer alignment is performed, the main control apparatus 20 first drives the fine motion stage WFS2 to position the measuring plate 86 mounted on the fine motion stage WFS2 directly below the primary alignment system AL1, which the main control apparatus 20 uses to detect the second fiducial mark. Furthermore, as disclosed in, for example, U.S. Patent Application Publication No. 2008/0088843, the main control apparatus 20 moves the wafer stage WST2 (i.e., the coarse motion stages WCS2 and the fine motion stage WFS2) in, for example, the −Y direction and positions the wafer stage WST2 at a plurality of locations along the travel path; furthermore, with each positioning, the main control apparatus 20 uses at least one of the alignment systems AL1, AL2₁-AL2₄ to detect the position of an alignment mark in the alignment shot region (i.e., the sample shot region). Let us consider a case involving, for example, four positionings: during the first positioning, for example, the main control apparatus 20 uses the primary alignment system AL1 and the secondary alignment systems AL2₂, AL2₃ to detect the alignment marks (hereinbelow, also called sample marks) in three sample shot regions; during the second positioning, the main control apparatus 20 uses the alignment systems AL1, AL2₁-AL2₄ to detect five sample marks on the wafer W; during the third positioning, the main control apparatus 20 uses the alignment systems AL1, AL2₁-AL2₄ to detect five sample marks; and during the fourth positioning, the main control apparatus 20 uses the primary alignment system AL1 and the secondary alignment systems AL2₂, AL2₃ to detect three sample marks. Thereby, the positions of the alignment marks in a total of 16 alignment shot regions can be obtained in a markedly shorter time than in the case wherein a single alignment system sequentially detects the 16 alignment marks. In this case, the alignment systems AL1, AL2₂, AL2₃ detect—in conjunction with the abovementioned operation of moving the wafer stage WST2—the plurality of alignment marks (i.e., sample marks) arrayed along the Y axial directions and sequentially disposed within the detection areas (e.g., corresponding to the areas irradiated by the detection beams). Consequently, when the abovementioned alignment marks are measured, it is not necessary to move the wafer stage WST2 in the X directions.

In the present embodiment, when performing the wafer alignment, including the detection of the second fiducial mark, the main control apparatus 20 uses the fine motion stage position measuring system 70B, including the measuring arm 71B, to measure the position within the XY plane of the fine motion stage WFS2 supported by the coarse motion stages WCS2 during the wafer alignment. However, the present invention is not limited thereto; for example, if the fine motion stage WFS2 is moved integrally with the coarse motion stages WCS2 during the wafer alignment, then the wafer alignment may be performed while measuring the position of the wafer W via the wafer stage position measuring system 16B as discussed above. In addition, because the measurement station 300 and the exposure station 200 are spaced apart, the position of the fine motion stage WFS2 during the wafer alignment and during the exposure is controlled using different coordinate systems. Accordingly, the main control apparatus 20 converts the array coordinates of each of the shot regions on the wafer W, which were obtained as a result of the wafer alignment, to array coordinates wherein the second fiducial mark serves as a reference.

In so doing, the wafer alignment of the wafer W held by the fine motion stage WFS2 is complete.

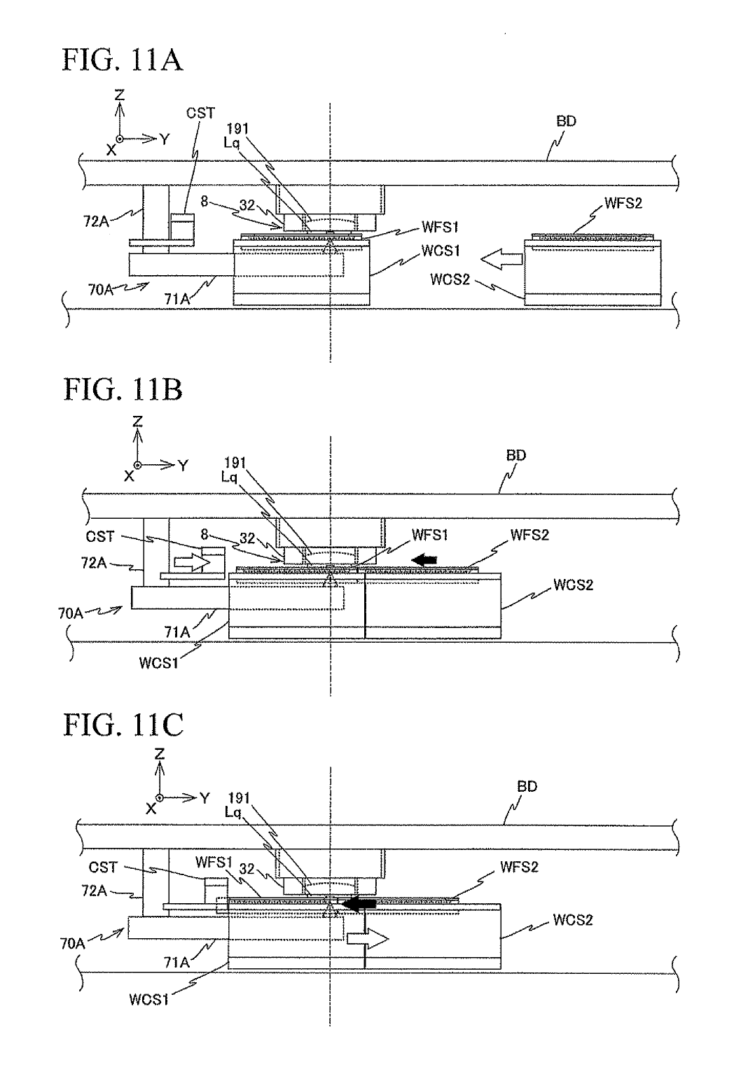

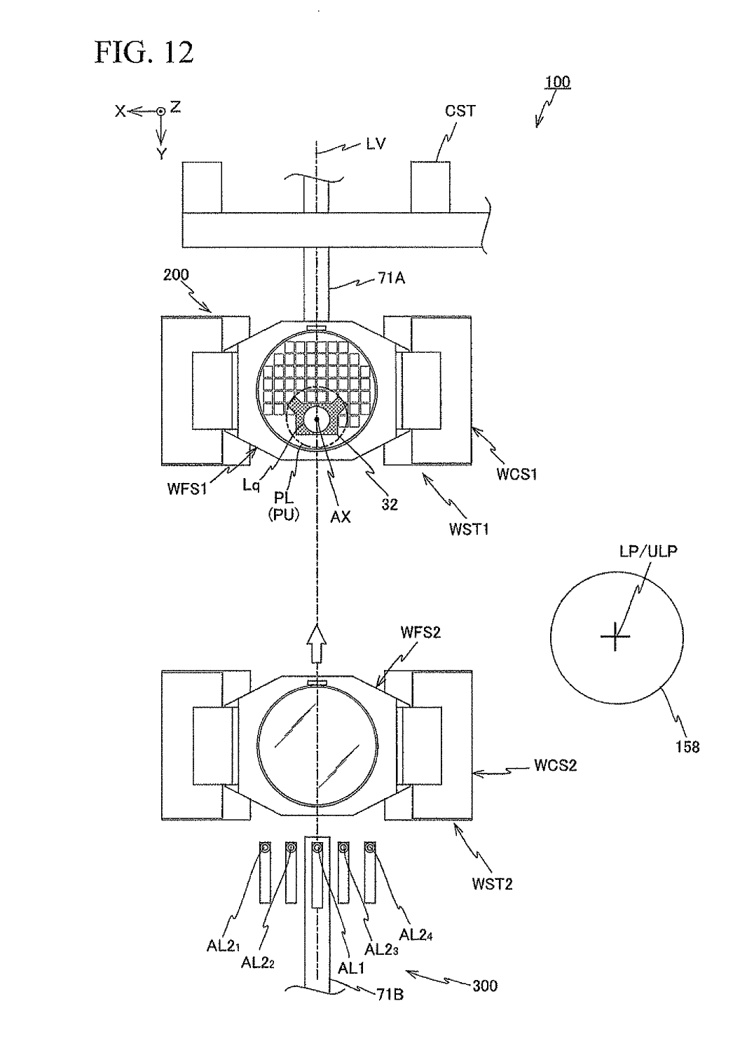

When the alignment is complete, the main control apparatus 20 drives the wafer stage WST2, namely, the coarse motion stages WCS2 that support the fine motion stage WFS2, toward the exposure station 200. FIG. 11A and FIG. 12 show the state wherein the coarse motion stages WCS2 that support the fine motion stage WFS2 are being moved from the measurement station 300 toward the exposure station 200. At this time, the transport stage CST stands by at the standby position discussed above.

When the coarse motion stages WCS2 that support the fine motion stage WFS2 have advanced in the −Y direction by a prescribed distance from the position shown in FIG. 11A and reach a position in the vicinity of the exposure station 200, the main control apparatus 20 waits for the completion of the exposure of the wafer W on the fine motion stage WFS1 in the state wherein the coarse motion stages WCS2 (i.e., the wafer stage WST2) are placed on standby at that position.

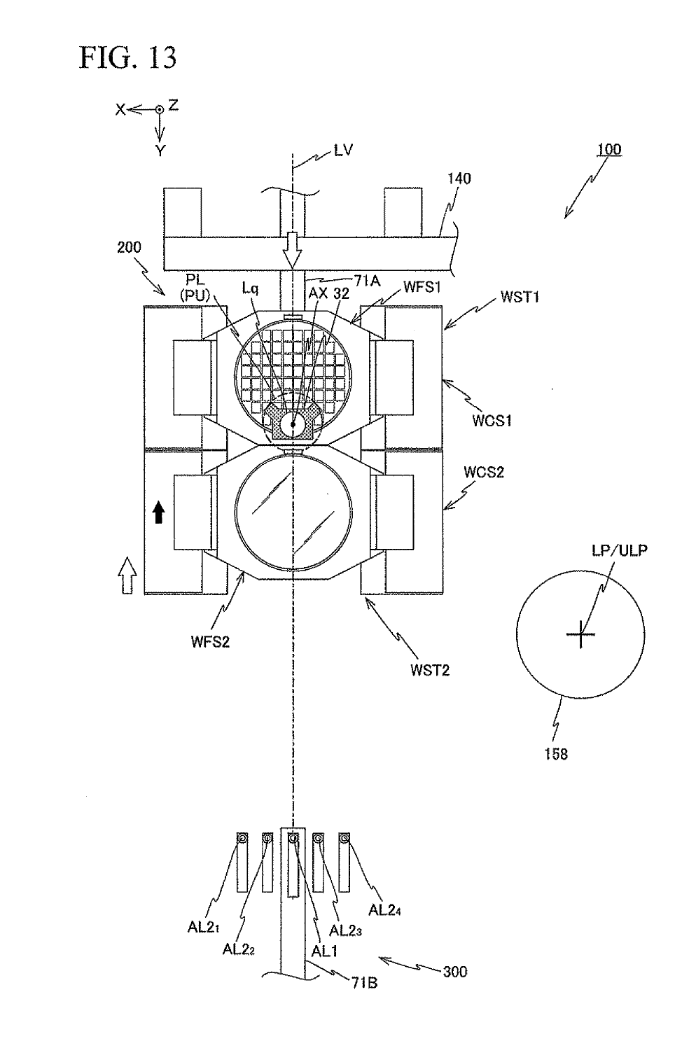

Furthermore, when the exposure is complete, the main control apparatus 20, as shown in FIG. 11B and FIG. 13, causes the coarse motion stages WCS2 and the coarse motion stages WCS1 to oppose one another in a state of substantial contact and drives the fine motion stage WFS2 in the −Y direction via the fine motion stage drive system 52B, as shown by the solid arrow in FIG. 11(B), so as to bring the fine motion stage WFS2 into contact with the fine motion stage WFS1 or into close proximity with the fine motion stage WFS1 across a clearance of approximately 300 μm in the Y axial directions. Namely, the main control apparatus 20 sets the fine motion stage WFS2 and the fine motion stage WFS1 to a “scrum” state. Furthermore, the preparation for setting the “scrum” state between the fine motion stage WFS2 and the fine motion stage WFS1 may be performed immediately before the completion of the exposure.

In addition, immediately after (or immediately before) the completion of the exposure of the wafer W on the fine motion stage WFS1, the main control apparatus 20 drives the transport stage CST, integrally with the robot arm 140, in the +Y direction and, as shown in FIG. 11B and FIG. 13, causes the transport stage CST and the coarse motion stages WCS1 to oppose one another in a proximate state.

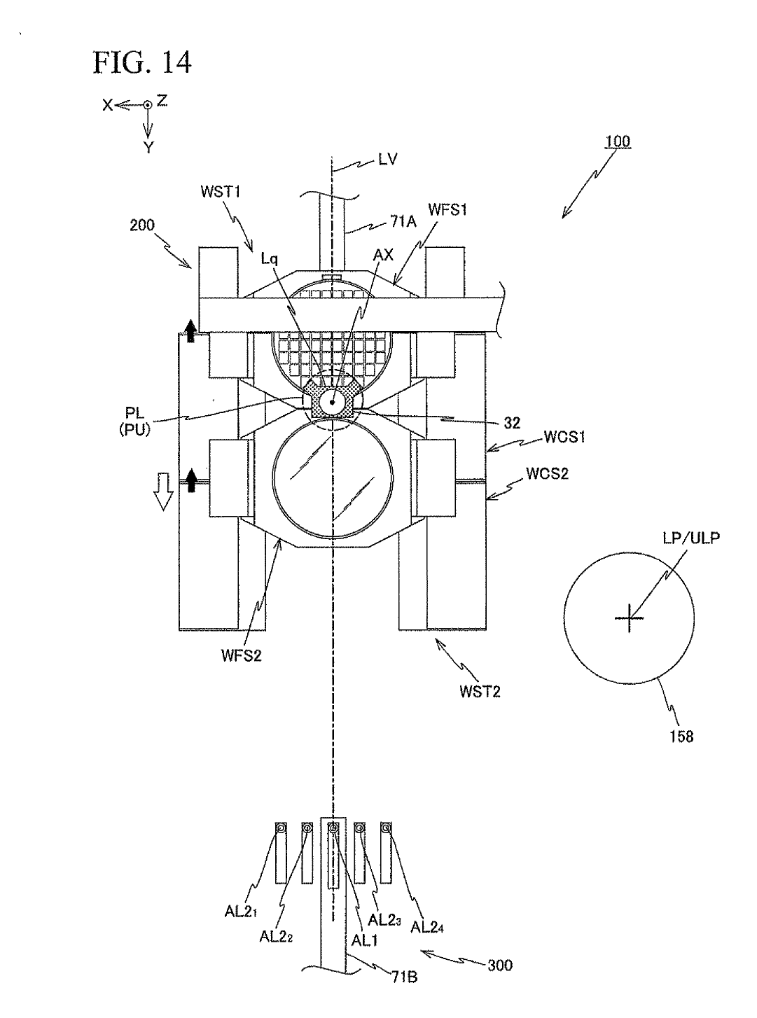

Next, the main control apparatus 20 simultaneously (while maintaining the “scrum” state as is) drives the fine motion stages WFS2, WFS1 in the −Y direction via the fine motion stage drive systems 52B, 52A as shown by the solid arrow in FIG. 11C and FIG. 14. Thereby, an immersion space, which is formed by the liquid Lq held between the fine motion stage WFS1 and the tip lens 191, is transferred from the fine motion stage WFS1 to the fine motion stage WFS2. FIG. 11C and FIG. 14 show the state immediately before the immersion space, which is formed from the liquid Lq, is transferred from the fine motion stage WFS1 to the fine motion stage WFS2. In this state, the liquid Lq is held between the tip lens 191 on one side and the fine motion stage WFS1 and the fine motion stage WFS2 on the other side.

In addition, in parallel with driving the fine motion stages WFS2, WFS1 in the −Y direction, the main control apparatus 20 simultaneously drives the coarse motion stages WCS1, WCS2 in the +Y direction, as shown by the outlined arrow in FIG. 11C.

In addition, when the transfer of the immersion space is started and the tip of the fine motion stage WFS1 begins to be exposed to the outside of the coarse motion stages WCS1, the main control apparatus 20 drives, in parallel with each of the operations mentioned above, the fine motion stage drive system 52C and starts the transfer (i.e., the sliding movement) of the fine motion stage WFS1 from the coarse motion stages WCS1 to the transport stage CST, as shown in FIG. 11C and FIG. 14.

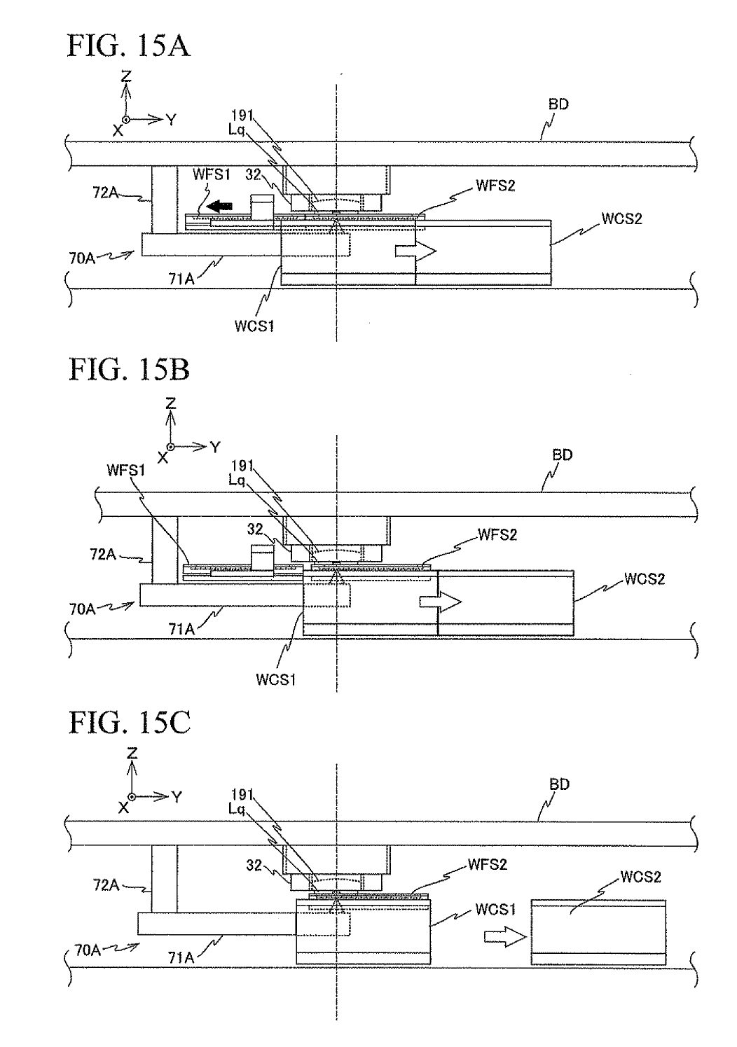

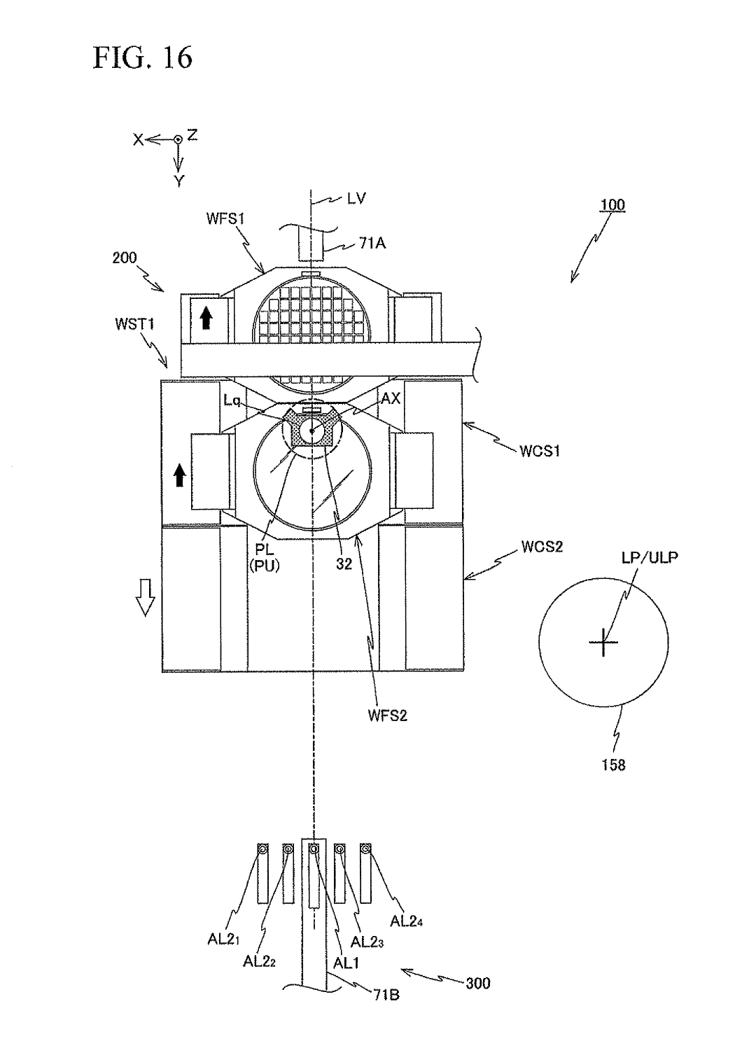

FIG. 15A and FIG. 16 show the state wherein the transfer of the immersion space is complete and the transfer of the fine motion stage WFS1 from the coarse motion stages WCS1 to the transport stage CST is nearly complete.

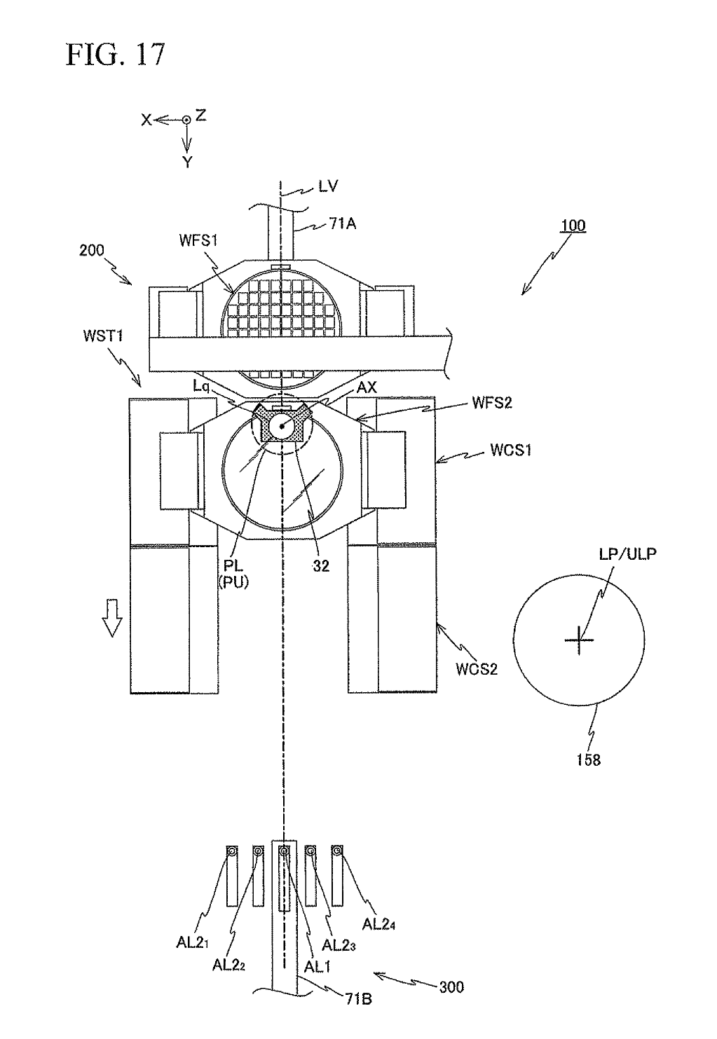

FIG. 15B and FIG. 17 show the state wherein a prescribed time has elapsed since the state shown in FIG. 15A and FIG. 16, and the transfer of the fine motion stage WFS1 from the coarse motion stages WCS1 to the transport stage CST is complete. At this time, the fine motion stage WFS2 is supported by the coarse motion stages WCS1. Namely, in the present embodiment, the transfer of the fine motion stage (in this case, WFS2) that holds the wafer W that had been aligned from the coarse motion stages WCS2 to the coarse motion stages WCS1 is completed in parallel with the transfer of the immersion space between the abovementioned fine motion stages WFS1, WFS2 and the transfer of the fine motion stage WFS1 from the coarse motion stages WCS1 to the transport stage CST.

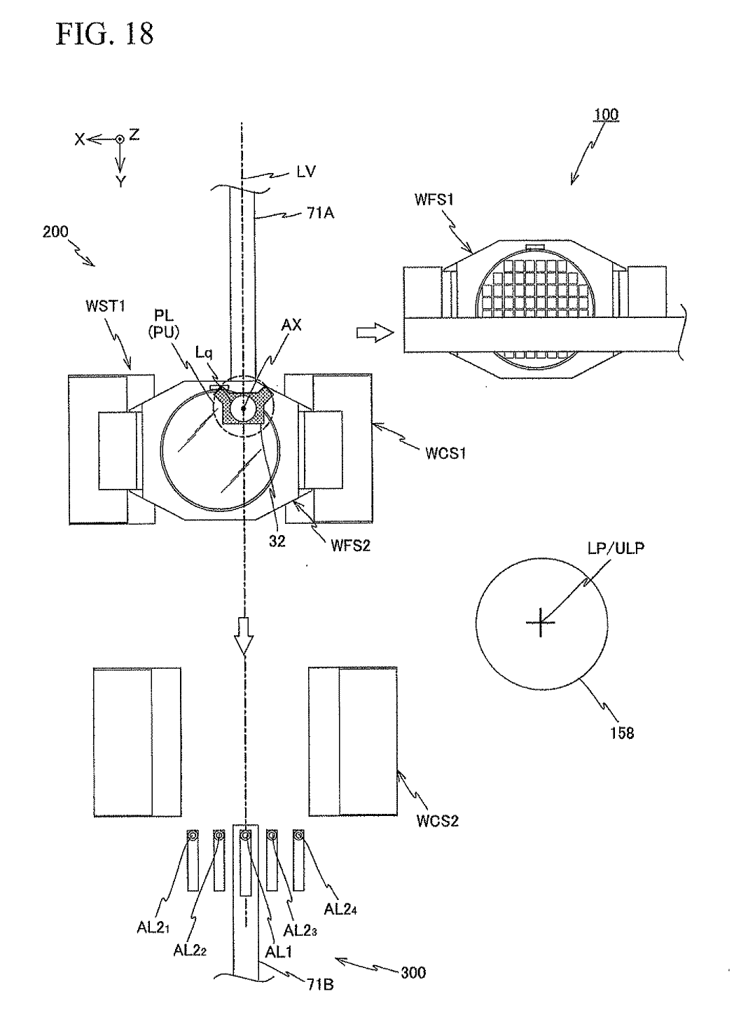

Next, as shown in FIG. 15C and FIG. 18, the exposure of the wafer W on the fine motion stage WFS2 is started. Prior to the start of an exposure, the main control apparatus 20 uses the pair of reticle alignment systems RA1, RA2, the pair of first fiducial marks on the measuring plate 86 of the fine motion stage WFS2, and the like, all of which were discussed above, to perform a reticle alignment using a procedure identical to that of a regular scanning stepper (e.g., the procedure disclosed in U.S. Pat. No. 5,646,413). Furthermore, based on the results of the reticle alignment and of the wafer alignment (i.e., the array coordinates of each shot region on the wafer W wherein the second fiducial mark serves as a reference), the main control apparatus 20 performs step-and-scan type exposure operations to transfer the pattern of the reticle R to the plurality of shot regions on the wafer W. These exposures are performed on the shot regions of the wafer W in order from the −Y side shot regions to the +Y side shot regions.

The operations described in a-e below are performed in parallel with the abovementioned reticle alignment and exposure.

a. Namely, starting from the state shown in FIG. 15B and FIG. 17 discussed above, the main control apparatus 20 drives the transport stage CST, which holds the fine motion stage WFS1, in the −X direction and moves it to the outside of the base plate 12, as shown by the outlined arrow in FIG. 18. FIG. 15C shows the state corresponding to FIG. 18.

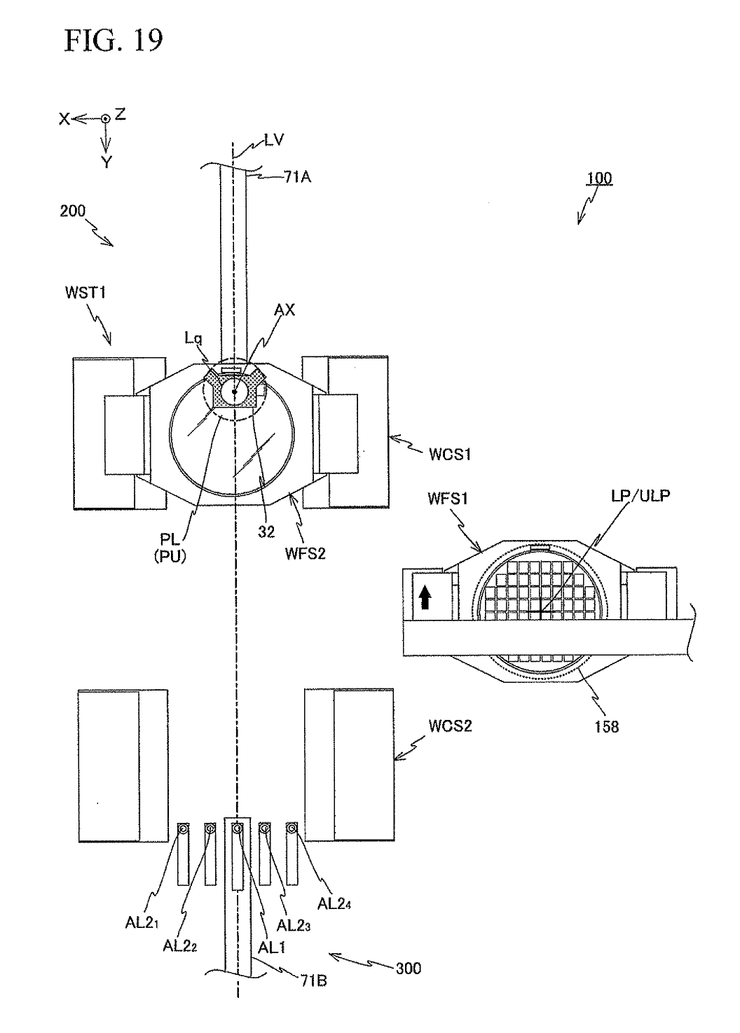

b. In parallel with the abovementioned movement of the transport stage CST, the main control apparatus 20 drives the coarse motion stages WCS2 in the +Y direction toward the measurement station 300, as shown by the outlined arrow in FIG. 15C and FIG. 18. FIG. 19 shows the state wherein the coarse motion stages WCS2 have moved to the measurement station 300. At this time, the main control apparatus 20 transports the transport stage CST, which supports the fine motion stage WFS1, to the wafer exchange position LP/ULP.

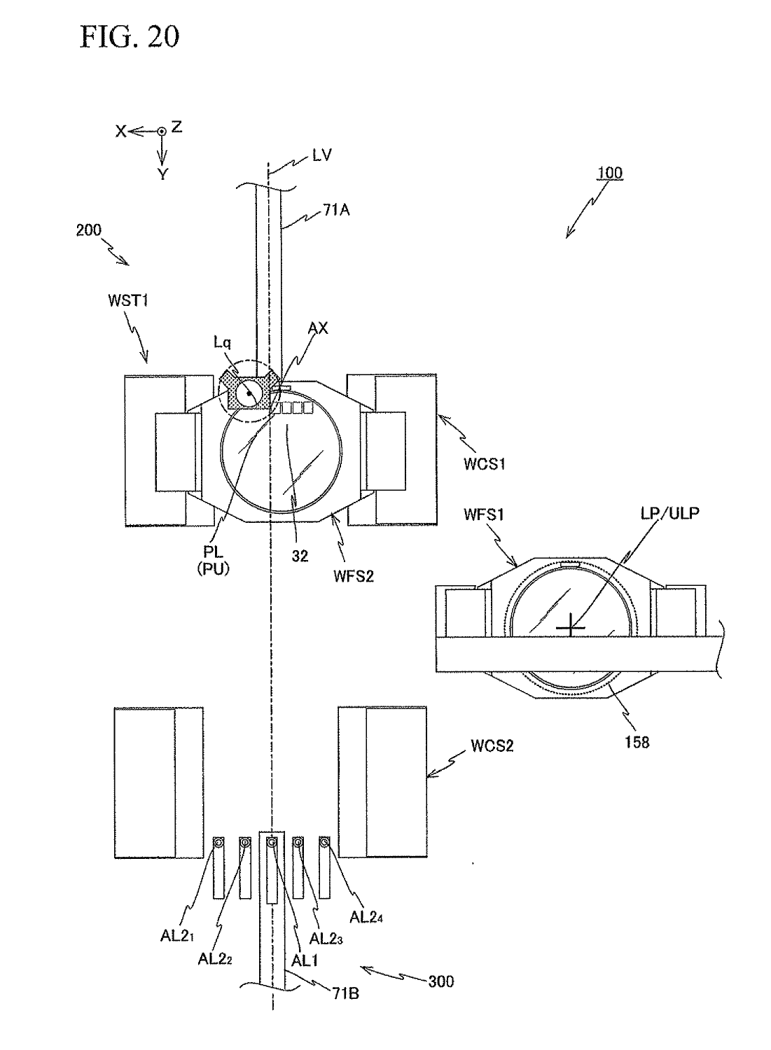

Furthermore, as shown in FIG. 19 and FIG. 20, at the wafer exchange position LP/ULP, an unloading arm and a loading arm (both of which are not shown) exchange the exposed wafer W on the fine motion stage WFS1 with an unexposed (i.e., a new) wafer W. Here, as one example, the unloading arm and the loading arm each have a so-called Bernoulli chuck.

Wafer exchange is performed in the state wherein the fine motion stage WFS1, which is supported by the transport stage CST, is mounted on the table 158, which is installed at the wafer exchange position LP/ULP. At this time, the fine motion stage WFS1 and the table 158 are connected via two types of conduits: one for supplying gas and one for exhausting gas. Furthermore, when the unloading arm is to unload the exposed wafer W from the wafer holder, the main control apparatus 20 drives a pressurized gas supply pump, which is connected to the gas supply conduit, blows gas, via the pressurized gas supply conduit, into a pressure reducing chamber (i.e., a pressure reducing space) formed by the wafer holder (not illustrated) of the fine motion stage WFS1 and a rear surface of the wafer W, releases the negative pressure state in the pressure reducing chamber, and thereby lifts the wafer W upward. When the unloading of the wafer W is complete, the main control apparatus 20 stops the pressurized gas supply pump and uses a check valve (not shown) inside the gas supply conduit in the fine motion stage WFS1 to close the conduit.

Moreover, when an unexposed new wafer W is to be loaded on the wafer holder, the main control apparatus 20 drives a vacuum pump, which is connected to a gas exhaust conduit; thereby, the pressure reducing chamber (i.e., the pressure reducing space), which is formed by the wafer holder of the fine motion stage WFS1 and the rear surface of the wafer W, transitions to the negative pressure state, which chucks the wafer W to the wafer holder.

When the wafer exchange is complete, the main control apparatus 20 stops the vacuum pump and closes the gas exhaust conduit inside the fine motion stage WFS1 via a check valve (not shown) inside the conduit. Furthermore, when the table 158 is lowered, the connection between the fine motion stage WFS1 and the table 158 via the conduit is released; however, the check valve maintains the negative pressure state in the pressure reducing chamber and the wafer holder maintains the wafer in the chucked state.

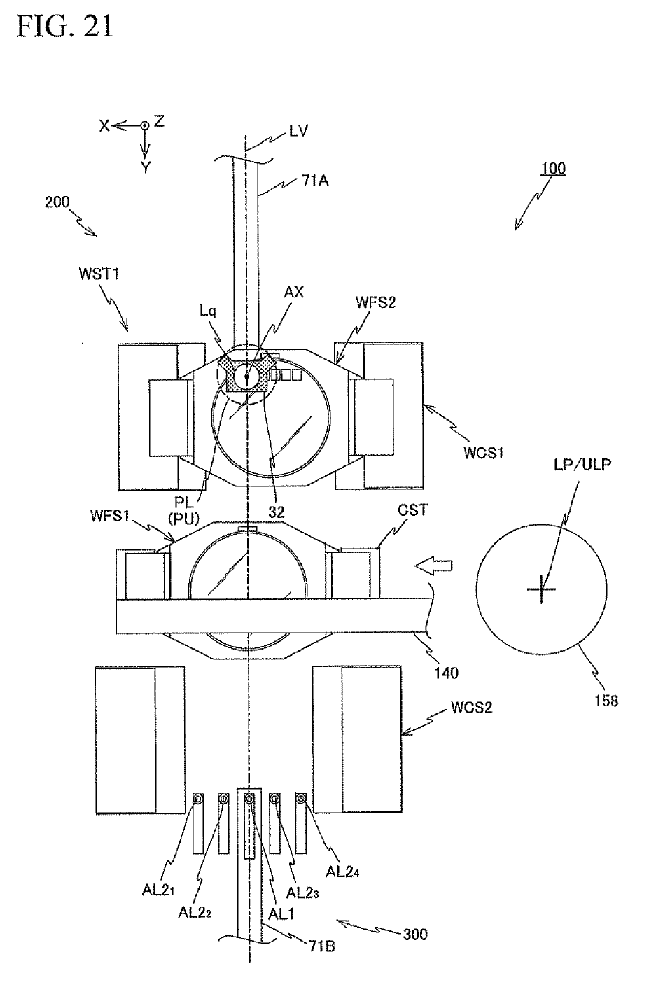

c. After the wafer exchange, the main control apparatus 20 drives the robot arm 140 in the +X direction, as shown by the outlined arrow in FIG. 21, and drives the fine motion stage WFS1, which holds the unexposed wafer W (i.e., the new wafer), in the +X direction integrally with the transport stage CST. Thereby, the transport stage CST opposes the coarse motion stages WCS2 (refer to FIG. 21). At this time, the exposure of the wafer W on the fine motion stage WFS2 continues.

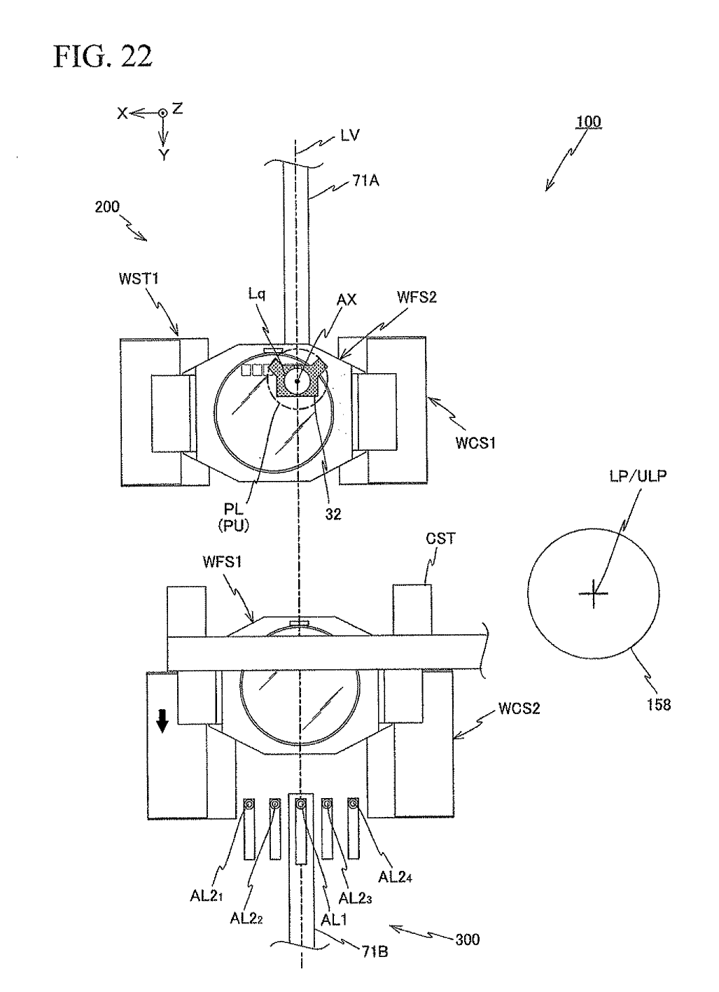

d. Next, the main control apparatus 20 drives the robot arm 140 in the +Y direction, moves the transport stage CST, which supports the fine motion stage WFS1 that holds the unexposed wafer W, in the +Y direction, and causes the transport stage CST to oppose the coarse motion stages WCS2 in a state of substantial contact. Furthermore, the main control apparatus 20 drives the fine motion stage WFS1 in the +Y direction, as shown by the solid arrow in FIG. 22, and transfers the fine motion stage WFS1 from the transport stage CST to the coarse motion stages WCS2. FIG. 22 shows the state wherein the fine motion stage WFS1 is being transferred to the coarse motion stages WCS2.

e. Subsequently, to detect the second fiducial mark on the fine motion stage WFS1 supported by the coarse motion stages WCS2, the main control apparatus 20 drives the fine motion stage WFS1 in the +Y direction, as shown in FIG. 23. Furthermore, the main control apparatus 20 performs procedures identical to those discussed above, for example, the detection of the second fiducial mark on the fine motion stage WFS1, the alignment of the wafer W on the fine motion stage WFS1, and the like. Furthermore, the main control apparatus 20 converts the array coordinates of each shot region on the wafer W obtained as a result of the wafer alignment to array coordinates wherein the second fiducial mark serves as the reference. In this case, too, when the alignment is performed, the fine motion stage position measuring system 70B is used to measure the position of the fine motion stage WFS1. FIG. 22 shows the state wherein the wafer W is being aligned on the fine motion stage WFS1. Before this, the transport stage CST moves to the vicinity of the wafer exchange position LP/ULP, as shown in FIG. 23.

The state shown in FIG. 22 is identical to the state shown in FIG. 2 discussed above, namely, the wafer W held by the fine motion stage WFS2 at the exposure station 200 is being exposed as discussed above and the wafer W held by the fine motion stage WFS1 at the measurement station 300 is being aligned.

Subsequently, the main control apparatus 20 sequentially uses the fine motion stages WFS1, WFS2 to repetitively perform parallel processes identical to those discussed above and continuously performs the exposing process on a plurality of the wafers W.

According to the exposure apparatus 100 of the present embodiment as explained in detail above, when transitioning from the state wherein the liquid Lq is held between the wafer W on the fine motion stage WFS1 (or WFS2) and the projection optical system PL (i.e., the tip lens 191) to the state wherein the liquid Lq is held between the wafer W on the fine motion stage WFS2 (or WFS1) and the projection optical system PL (i.e., the tip lens 191), the main control apparatus 20 moves the fine motion stages WFS1, WFS2 in one of the Y axial directions while maintaining the state wherein the fine motion stages WFS1, WFS2 are in close proximity or contact with one another in the Y axial directions (i.e., the “scrum” state) and moves the coarse motion stages WCS1, WCS2 in the opposite direction. Consequently, it is possible to maximize throughput while continuously maintaining the immersion space between at least one of the fine motion stages WFS1, WFS2 on one side and the projection optical system PL (i.e., the tip lens 191) on the other side. Additionally, the exposure apparatus 100 makes it possible to perform the operation of switching the mounting of the fine motion stage WFS2 (or WFS1), which holds the wafer W that has been aligned, from the coarse motion stages WCS2 to the coarse motion stages WCS1 in parallel with the operation of the state transition (i.e., the transfer of the immersion space). Accordingly, it is possible to start the exposure operation promptly. Furthermore, it is also acceptable if only part of the operation of switching the mounting of the fine motion stage WFS2 (or WFS1), which holds the wafer W that has been aligned, from the coarse motion stages WCS2 to the coarse motion stages WCS1 is performed in parallel with the operation of the state transition (i.e., the transfer of the immersion space).

In addition, because the transfer of the fine motion stages between the coarse motion stages WCS1 (or WCS2) and the transport stage CST can be performed merely by sliding the fine motion stages—and without, for example, an accompanying operation that separates the coarse motion stages—the transfer can be performed rapidly. Accordingly, even if the object to be processed is a 450 mm wafer and the like, the wafer process can be performed while maximizing throughput.

In addition, according to the exposure apparatus 100 of the present embodiment, a measurement surface, wherein the grating RG is formed, is provided to one surface of each of the fine motion stages WFS1, WFS2 such that this measurement surface is substantially parallel to the XY plane. The fine motion stage WFS1 (or WFS2) is held by the coarse motion stages WCS1 (or WCS2) such that it is capable of relative motion along the XY plane. Furthermore, the fine motion stage position measuring system 70A (or 70B) comprises the X head 77x and the Y heads 77ya, 77yb, which are disposed such that they oppose the measurement surface wherein the grating RG is formed inside the space of the coarse motion stages WCS1, radiates the pairs of measurement beams LBx₁, LBx₂, LBya₁, LBya₂, LByb₁, LByb₂ to the measurement surface, and receives the lights of the measurement beams (e.g., the combined beams LBx₁₂, LBya₁₂, LByb₁₂ of the first order diffraction beams, which are produced by the grating RG, of the measurement beams) from the measurement surface. Furthermore, the fine motion stage position measuring system 70A (or 70B) measures, based on the outputs of the X head 77x and the Y heads 77ya, 77yb, the position at least within the XY plane (including the rotation in the θz directions) of the fine motion stage WFS1 (or WFS2). Consequently, the X head 77x and the Y heads 77ya, 77yb radiate the pairs of measurement beams LBx₁, LBx₂, LBya₁, LBya₂, LByb₁, LByb₂ to the measurement surface wherein the grating RG of the fine motion stage WFS1 (or WFS2) is formed, which makes it possible to accurately measure the position of the fine motion stage WFS1 (or WFS2) within the XY plane via the so-called rear surface measurement method. Furthermore, the main control apparatus 20 drives the fine motion stage WFS1 (or WFS2) independently or integrally with the coarse motion stages WCS1 (or WCS2) based on the position measured by the fine motion stage position measuring system 70A (or 70B) via either the fine motion stage drive system 52A or the fine motion stage drive system 52A and the coarse motion stage drive system 51A (or via either the fine motion stage drive system 52B or the fine motion stage drive system 52B and the coarse motion stage drive system 51B). In addition, as discussed above, there is no need to provide a vertically moving member on the fine motion stage, and therefore even adopting the abovementioned rear surface measurement technique poses no particular obstacles.

In addition, in the exposure station 200 according to the exposure apparatus 100 of the present embodiment, the wafer W mounted on the fine motion stage WFS1 (or WFS2), which is held such that it is capable of moving relative to the coarse motion stages WCS1, is exposed with the exposure light IL through the reticle R and the projection optical system PL. At this time, the main control apparatus 20 uses the encoder system 73 of the fine motion stage position measuring system 70A, which comprises the measuring arm 71A that opposes the grating RG disposed on the fine motion stage WFS1 (or WFS2), to measure the position of the fine motion stage WFS1 (or WFS2), which is movably held by the coarse motion stages WCS1, within the XY plane. In this case, a space is formed inside the coarse motion stages WCS1 and each of the heads of the fine motion stage position measuring system 70A are disposed in that space; therefore, space exists only between the fine motion stage WFS1 (or WFS2) and the heads of the fine motion stage position measuring system 70A. Accordingly, each of the heads can be disposed in close proximity to the fine motion stage WFS1 (or WFS2) (i.e., the grating RG), which makes it possible to measure the position of the fine motion stage (or WFS2) with high accuracy using the fine motion stage position measuring system 70A. In addition, as a result, the main control apparatus 20 can drive the fine motion stage WFS1 (or WFS2) with high accuracy via the coarse motion stage drive system 51A and/or the fine motion stage drive system 52A.

In addition, in this case, the irradiation point on the grating RG of each measurement beam emerging from the measuring arm 71A of each head of the encoder system 73 and the laser interferometer system 75—such systems constituting the fine motion stage position measuring system 70A—coincides with the center (i.e., the exposure position) of the irradiation area IA (i.e., the exposure area) of the exposure light IL radiated to the wafer W. Accordingly, the main control apparatus 20 can measure the position of the fine motion stage WFS1 (or WFS2) with high accuracy without being affected by so-called Abbé error. In addition, disposing the measuring arm 71A directly below the grating RG makes it possible to greatly shorten the in-air optical path lengths of the measurement beams of the heads of the encoder system 73, which in turn reduces the effects of air turbulence and also makes it possible to measure the position of the fine motion stage WFS1 (or WFS2) with high accuracy.

In addition, in the present embodiment, the measurement station 300 is provided with the fine motion stage position measuring system 70B, which is configured such that it is bilaterally symmetric with the fine motion stage position measuring system 70A. Furthermore, in the measurement station 300, when the alignment systems AL1, AL2₁-AL2₄ and the like perform the wafer alignment on the wafer W on the fine motion stage WFS2 (or WFS1) held by the coarse motion stages WCS2, the fine motion stage position measuring system 70B measures with high accuracy the position of the fine motion stage WFS2 (or WFS1), which is movably held by the coarse motion stages WCS2, within the XY plane. As a result, the main control apparatus 20 can drive the fine motion stage WFS2 (or WFS1) with high accuracy via the coarse motion stage drive system 51B and/or the fine motion stage drive system 52B.

Accordingly, for example, by exposing the wafer W with the illumination light IL, the pattern can be formed accurately over the entire surface of the wafer W.

In addition, according to the exposure apparatus 100 of the present embodiment, the fine motion stage WFS1 (or WFS2) can be accurately driven, which makes it possible to accurately drive the wafer W mounted on the fine motion stage WFS1 (or WFS2) synchronously with the reticle stage RST (i.e., the reticle R) and thereby to accurately transfer the pattern on the reticle R to the wafer W via a scanning exposure.

Furthermore, the abovementioned embodiment explained a case wherein the exposure apparatus 100 is provided with the two fine motion stages WFS1, WFS2, but the present invention is not limited thereto; for example, the exposure apparatus 100 may be provided with three or more fine motion stages, as in the modified examples below.

### MODIFIED EXAMPLES

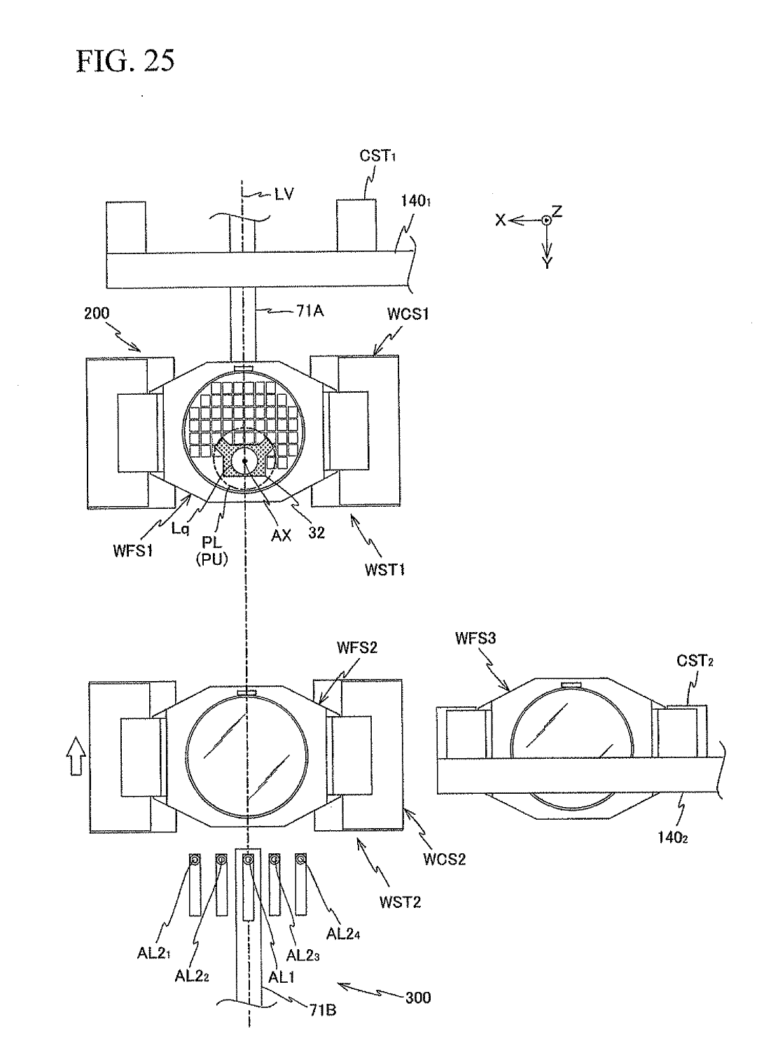

The following text explains the exposure apparatus according to modified examples of the present embodiment, referencing FIG. 25 through FIG. 29. As shown in FIG. 25, the exposure apparatus according to a second modified example comprises the three fine motion stages WFS1, WFS2, WFS3. In addition, the exposure apparatus according to the second modified example is provided with two of the transport stages CST and two of the robot arms. Herein below, these are distinguished according to the denotations transport stages CST₁, CST₂ and robot arms 140₁, 140₂.

FIG. 25 shows the exposure apparatus according to the modified example in the state wherein the fine motion stage WFS1 is at the exposure station 200, the exposure discussed above is being performed on the wafer W held by the fine motion stage WFS1, and the coarse motion stages WCS2, which support the fine motion stage WFS2, are being moved from the measurement station 300 toward the exposure station 200. At this time, the transport stage CST₁ is standing by at the standby position; in addition, the fine motion stage WFS3, which holds the new wafer W, is supported by the transport stage CST₂ and is standing by at the standby position on the −X side slightly to the +Y side of the measurement station 300.

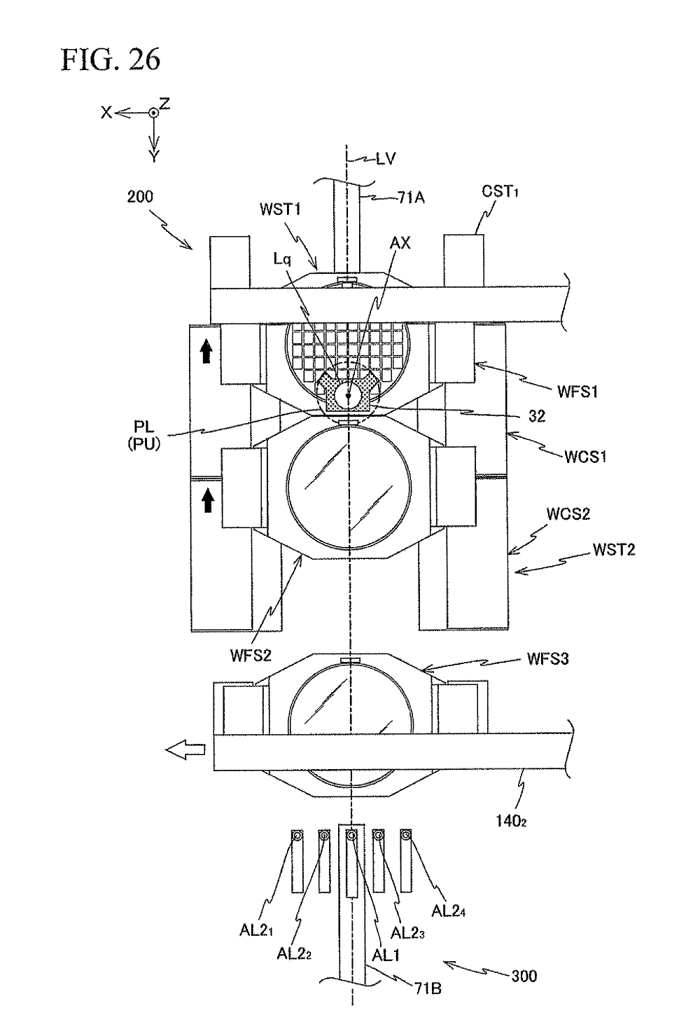

When the coarse motion stages WCS2, which support the fine motion stage WFS2, have moved in the −Y direction by a prescribed distance from the position shown in FIG. 25 and reach the position in the vicinity of the exposure station 200, the main control apparatus 20 causes the coarse motion stages WCS2 to stand by at that position until the exposure is complete. Furthermore, when the exposure is complete, the main control apparatus 20 causes the coarse motion stages WCS2 and the coarse motion stages WCS1 to oppose one another in a state of substantial contact, sets the fine motion stage WFS2 and the fine motion stage WFS1 to the “scrum” state, and then drives the fine motion stage WFS2 and the fine motion stage WFS1 in the −Y direction while maintaining the “scrum” state as is, as indicated by the solid arrows in FIG. 26. Thereby, the immersion space formed by the liquid Lq held between the fine motion stage WFS1 and the tip lens 191 begins to transfer from the fine motion stage WFS1 to the fine motion stage WFS2.

In addition, when the transfer of the immersion space begins and the tip of the fine motion stage WFS1 begins to be exposed to the outside of the coarse motion stages WCS1, the main control apparatus 20 begins the transfer (i.e., the sliding movement) of the fine motion stage WFS1 from the coarse motion stages WCS1 to the transport stage CST₁, as shown in FIG. 26. At this time, the main control apparatus 20 drives the coarse motion stages WCS1, WCS2 simultaneously in the +Y direction, as discussed above.

Moreover, to set the fine motion stages WFS2, WFS1 to the “scrum” state discussed above, first, when the coarse motion stages WCS2 are brought into close proximity with the coarse motion stages WCS1, the main control apparatus 20 drives the robot arm 140₂ in the +X direction, as indicated by the outlined arrow in FIG. 26, and moves the transport stage CST₂ to a position on the +Y side of the coarse motion stages WCS2.

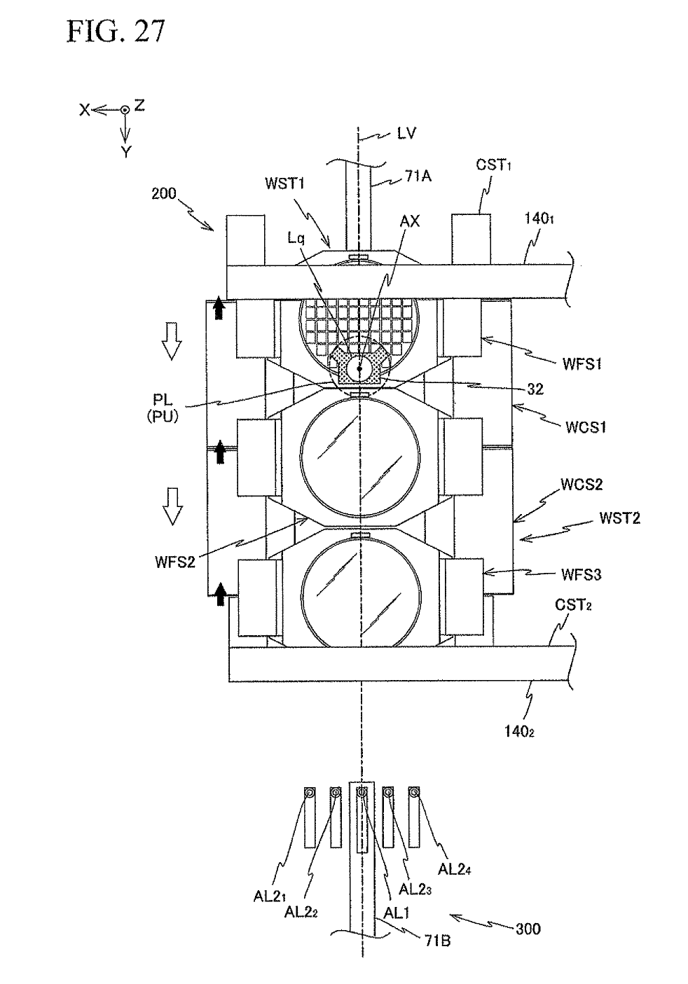

Next, as indicated by the outlined arrows in FIG. 27, the main control apparatus 20 drives the robot arm 140₁ in the +Y direction, causes the transport stage CST₂ to oppose the coarse motion stages WCS2 in a state of substantial contact, and furthermore sets the fine motion stage WFS3 to the “scrum” state with respect to the fine motion stage WFS2, which is already in the “scrum” state with the fine motion stage WFS1. Furthermore, the main control apparatus 20 drives the three fine motion stages WFS1, WFS2, WFS3 while maintaining the “scrum” state as is, as indicated by the solid arrows in FIG. 27. At this time, the main control apparatus 20 drives the coarse motion stages WCS1, WCS2 continuously in the direction opposite that of the fine motion stages WFS1, WFS2, WFS3 (refer to the outlined arrows) while driving the transport stage CST₂ and the coarse motion stages WCS1, WCS2 at the same velocity.

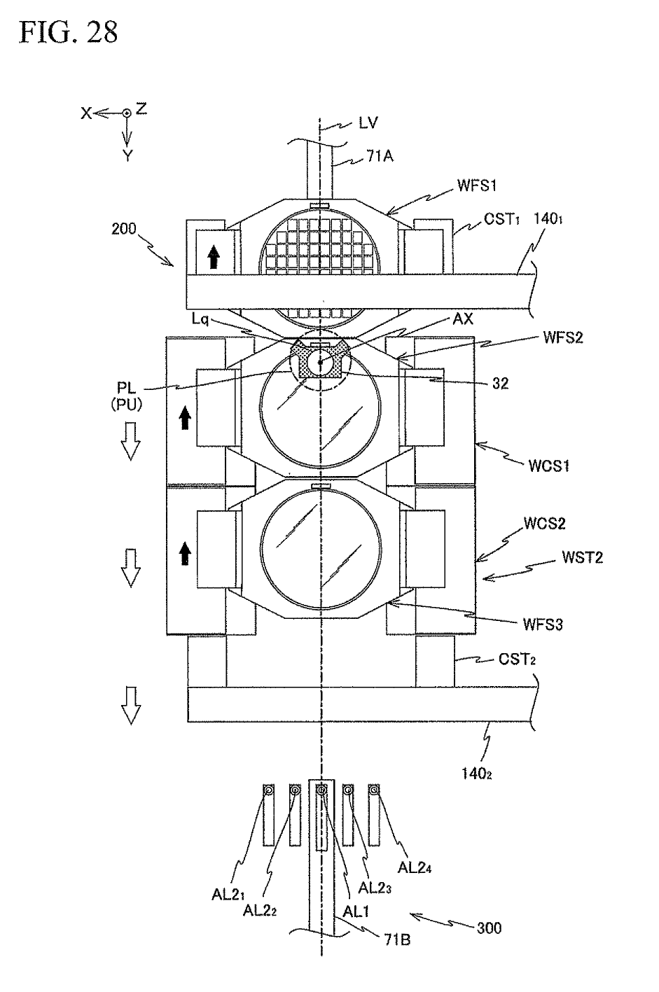

Furthermore, when a prescribed time has elapsed since the state shown in FIG. 27, the transfer of the immersion space is complete; continuing, as shown in FIG. 28, in addition the transfer of the fine motion stage WFS1 from the coarse motion stages WCS1 to the transport stage CST₁ and the transfer of the fine motion stage WFS2 from the coarse motion stages WCS2 to the coarse motion stages WCS1, the transfer of the fine motion stage that holds the new wafer W (in this case, the WFS3) from the transport stage CST₂ to the coarse motion stages WCS2 is also complete.

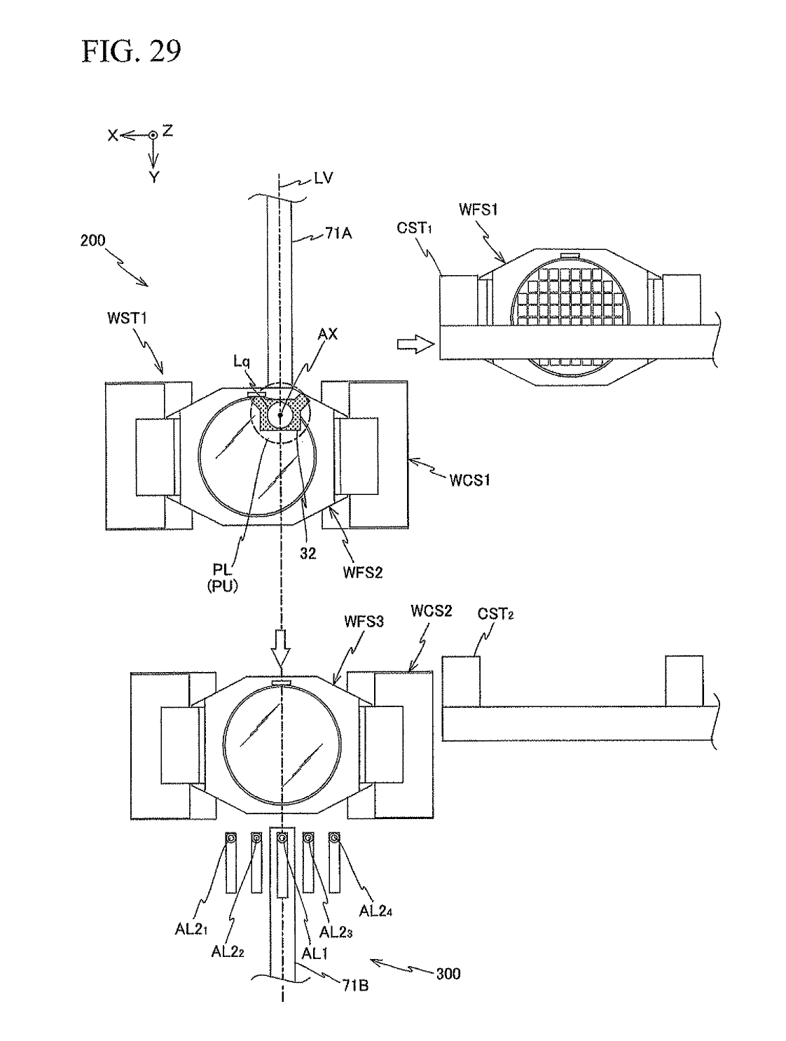

Next, the main control apparatus 20 drives the transport stage CST₁, which supports the fine motion stage WFS1, toward the wafer exchange position, as indicated by the outlined arrow in FIG. 29, and drives the transport stage CST₂ in the −X direction. In parallel with the abovementioned movement of the transport stage CST₂, the main control apparatus 20 drives the coarse motion stages WCS2 in the +Y direction toward the measurement station 300, as indicated by the outlined arrow in FIG. 29.

Subsequently, the main control apparatus 20 performs the parallel process operations, namely, the exposure of the wafer W held by the fine motion stage WFS2 and the alignment of the wafer W held by the fine motion stage WFS3, using the same procedures as in the embodiment discussed above. In addition, in parallel with these operations, the main control apparatus 20 performs the wafer exchange on the fine motion stage WFS1 in the same manner as in the embodiment discussed above. Furthermore, after the wafer exchange, the fine motion stage WFS1, which holds the new wafer, is transferred from the transport stage CST₁ to the transport stage CST₂. Thereby, the transport stage CST₂ stands by at the position shown in FIG. 25 in the state wherein the transport stage CST₂ supports the fine motion stage WFS1, which holds the new wafer.

In so doing, in the exposure apparatus according to the second modified example, the main control apparatus 20 repetitively performs the parallel processes using the three fine motion stages WFS1-WFS3.

The exposure apparatus according to the modified example as explained above obtains effects equivalent to those of the embodiment discussed above; furthermore, when the immersion space is transferred, in addition to the transfer of the fine motion stage WFS1 from the coarse motion stages WCS1 to the transport stage CST₁ and the transfer of the fine motion stage WFS2 from the coarse motion stages WCS2 to the coarse motion stages WCS1, the fine motion stage that holds the new wafer W (e.g., the WFS3) is transferred from the transport stage CST₂ to the coarse motion stages WCS2. Accordingly, the exposure operation that exposes the wafer on the fine motion stage WFS2 and the alignment operation performed on the fine motion stage WFS3 can be started immediately. In addition, in the exposure apparatus according to the second modified example, the fine motion stages WFS1-WFS3 circulate.

Furthermore, the abovementioned embodiment explained a case wherein the fine motion stage position measuring systems 70A, 70B are made entirely of, for example, glass and comprise the measuring arms 71A, 71B, wherethrough light can travel, but the present invention is not limited thereto. For example, the measuring arms 71A, 71B may have a hollow structure wherein at least the portions wherethrough each of the laser beams travel, which was discussed above, may be formed as solid members wherethrough light can travel, and the other portions may be formed as, for example, members that do not transmit light. In addition, for example, the measuring arms may be configured such that the light source, the photodetector, and the like are built into the tip part of the measuring arms as long as the measurement beams can be radiated from the portion that opposes the grating RG. In such a case, the measurement beams of the encoder would not have to travel through the interior of the measuring arms. Furthermore, the shapes of the measuring arms do not particularly matter. In addition, the fine motion stage position measuring systems 70A, 70B do not necessarily have to comprise the measuring arms, respectively, and may have some other configuration as long as each comprises a head disposed such that it opposes the grating RG disposed in the spaces of the coarse motion stages WCS1, WCS2, radiates at least one measurement beam to the grating RG, and receives a diffracted beam of the measurement beam from the grating RG, and as long as the position of the fine motion stage WFS1 (or WFS2) can be measured at least within the XY plane based on the output of that head.

In addition, the abovementioned embodiment explained an exemplary case wherein the encoder system 73 comprises the X head and the pair of Y heads, but the present invention is not limited thereto; for example, one or two two-dimensional heads (i.e., 2D heads), whose measurement directions are in two directions, namely, the X axial directions and the Y axial directions, may be provided. If two 2D heads are provided, then their detection points may be two points that are equidistantly spaced apart from the center of the exposure position on the grating (RG) in the X axial directions.

Furthermore, in the abovementioned embodiment, the grating is disposed on the upper surface of one of the fine motion stages namely, on the surface that opposes the wafer, but the present invention is not limited thereto; for example, the grating RG may be formed in the wafer holder, which holds the wafer. In such a case, even if the wafer holder expands during an exposure or if a mounting position deviates with respect to the fine motion stage, it is possible to track this deviation and still measure the position of the wafer holder (i.e., the wafer). In addition, the grating may be disposed on the lower surface of the fine motion stage; in such a case, the measurement beams radiated from the encoder heads would not travel through the interior of the fine motion stage and, therefore, the fine motion stage would not have to be a solid member wherethrough the light can transmit, the interior of the fine motion stage could have a hollow structure wherein piping, wiring, and the like could be disposed, and thereby the fine motion stage could be made more lightweight.

Furthermore, in the abovementioned embodiment, the fine motion stages WFS1, WFS2 can be driven in directions corresponding to a total of six degrees of freedom, but the present invention is not limited thereto; for example, any number of degrees of freedom is acceptable as long as the fine motion stages WFS1, WFS2 can move at least within a two dimensional plane that is parallel to the XY plane. In addition, the fine motion stages WFS1, WFS2 may be supported contactually by the coarse motion stages WCS1, WCS2. Accordingly, the fine motion stage drive systems 52A, 52B that drive the fine motion stages with respect to the coarse motion stages or a relay stage may each comprise a combination of, for example, a rotary motor and a ball screw (or a feed screw).

Furthermore, in the abovementioned embodiment, as one example of the measurement of the wafer W, an alignment mark measurement (i.e., a wafer alignment) is performed at the measurement station 300; however, in addition thereto (or instead), a surface position measurement that measures the position of the front surface of the wafer W in the directions of the optical axis AX of the projection optical system PL may be performed. In such a case, the surface position measurement of the upper surface of the fine motion stage that holds the wafer may be performed simultaneously with the above surface position measurement, as disclosed in, for example, U.S. Patent Application Publication No. 2008/0088843; furthermore, based on these results, the focus and leveling of the wafer W during an exposure may be controlled.

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred to an object with high accuracy. In addition, the present invention can also be adapted to a step-and-stitch type reduction projection exposure apparatus that stitches shot regions together.

In addition, the projection optical system PL in the exposure apparatus of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength laser light in the infrared region or the visible region that is generated from a DFB semiconductor laser or a fiber laser, and then using a nonlinear optical crystal for wavelength conversion to convert the output laser light to ultraviolet light.

In addition, in the exposure apparatus of the present invention, the illumination light IL thereof is not limited to light with a wavelength of 100 nm or greater; of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle beam, such as an electron beam or an ion beam.

In addition, in the abovementioned embodiment an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the abovementioned embodiment can be obtained by using the encoder system and a laser interferometer system to measure the position of the stage.

In addition, by forming interference fringes on the wafer W as disclosed in, for example, PCT International Publication No. WO2001/035168, the present invention can also be adapted to an exposure apparatus (i.e., a lithographic system) that forms a line-and-space pattern on the wafer W.

Furthermore, the present invention can also be adapted to, for example, an exposure apparatus that combines the patterns of two reticles onto a wafer via a projection optical system and double exposes, substantially simultaneously, a single shot region on the wafer using a single scanning exposure, as disclosed in, for example, U.S. Pat. No. 6,611,316.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus is not limited to an exposure apparatus for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a light exposure apparatus, an EUV exposure apparatus, an X-ray exposure apparatus, an electron beam exposure apparatus, and the like.

### Method of Fabricating a Device

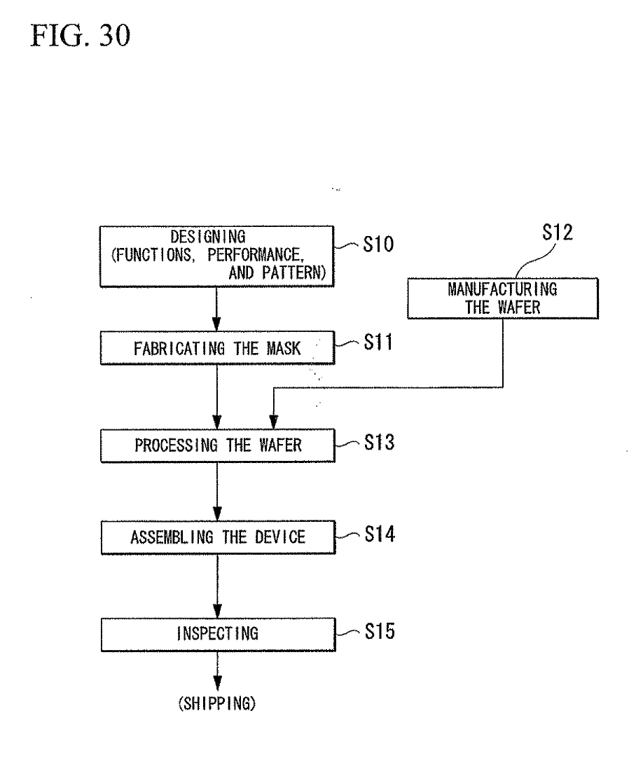

The following text explains an embodiment of a method of fabricating microdevices using the exposure apparatus and the exposing method according to the above-described embodiments in a lithographic process. FIG. 30 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

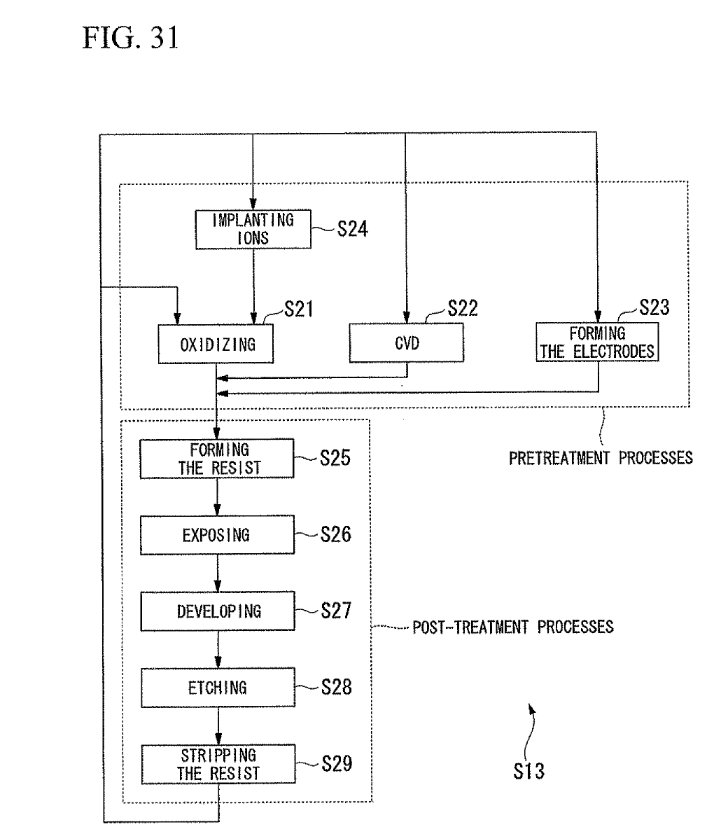

FIG. 31 depicts one example of the detailed process of the step S13 for the case of a semiconductor device.

In a step S21 (i.e., an oxidizing step), the front surface of the wafer is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist removing step), etching is finished and the resist that is no longer needed is stripped. Circuit patterns are superposingly formed on the wafer by repetitively performing the pretreatment and post-treatment processes.

As explained above, the exposure apparatus according to embodiments of the present invention is suitable for forming a pattern on an object by radiating an energy beam thereto. In addition, the device fabricating method according to embodiments of the present invention is suitable for fabricating electronic devices.

1. An exposure apparatus that exposes an object with an energy beam through an optical system and a liquid, comprising:
a plurality of holding members, which hold the object;
a first stage unit, which movably supports the holding members in an area within a two dimensional plane that includes a first position directly below the optical system; and
a second stage unit, that movably supports the holding members independently of the first stage unit in an area within the two dimensional plane that includes the first position and a second position, which is spaced apart from the first position;
wherein,
each of the first and second stage units comprises:
a first moving body, which comprises guide members that extend in a first direction, that moves in a second direction, which are substantially orthogonal to the first direction; and
two second moving bodies, which are provided such that they are capable of moving independently in the first direction along the guide members, that move in the second direction together with the guide members by the movement of the first moving body;
the first stage unit and the second stage unit are disposed adjacently in the second direction; and
the first holding member, which is supported by the first stage unit, and the second holding member, which is supported by the second stage unit, move in a direction parallel to the second direction while maintaining the state wherein they are in either close proximity or contact at end parts on the second direction side and transition from a first state, wherein a liquid is held between the object on the first holding member and the optical system, to a second state, wherein the liquid is held between the object on the second holding member and the optical system.

2. The exposure apparatus according to claim 1, further comprising:
a support member, which is capable of supporting the holding members such that they are capable of relative motion in a direction parallel to the second direction;
wherein,
each of the holding members is capable of moving with respect to one another between the second stage unit and the first stage unit; and
in the second state, the second holding member, which holds the unexposed object, is supported by the first stage unit, and the first holding member, which holds the exposed object, is supported by the support member.

3. The exposure apparatus according to claim 2, wherein
the support member is capable of moving within a plane that is parallel to the two dimensional plane; and
after the transition, in order to exchange the object, the support member moves to the exchange position, in the state wherein the support member supports the first holding member.

4. The exposure apparatus according to claim 3, wherein
at the exchange position, the exposed object, which is held by the first holding member, is exchanged with a new object.

5. The exposure apparatus according to claim 3, wherein
three or more of the holding members are provided; and
in order to exchange the object at the exchange position, the first holding member, which is supported by the support member, is exchanged with a separate holding member, which holds a new object.

6. The exposure apparatus according to claim 4, wherein
after the transition, the holding member that holds the new object is transported by the support member and transferred to the second moving bodies in parallel with the exposure of the object held by the second holding member.

7. The exposure apparatus according to claim 2, wherein
three or more of the holding members are provided;
a second support member, which has the same configuration as the support member, is prepared;
after the transition, the support member moves to the exchange position in the state wherein the support member supports the first holding member; and
the second support member moves to the vicinity of the second moving bodies in the state wherein the second support member supports a third holding member, which is separate from the first and second holding members and holds the unexposed object.

8. The exposure apparatus according to claim 7, wherein
during the transition, the third holding member, in parallel with at least one part of the movement of the first and second holding members to the other side of the direction parallel to the second direction while maintaining the state wherein the first and second holding members are in either close proximity or contact in the second direction, moves to the other side of the direction parallel to the second direction and is transferred from the second support member to the second stage unit.

9. The exposure apparatus according to claim 2, further comprising:
a measuring system, which is disposed at the second position and performs a prescribed measurement on the object held by any of the holding members on the second stage unit;
wherein,
in the first state prior to the state transition, the measuring system performs the prescribed measurement on the unexposed object in the state wherein the unexposed object is held on the holding member.

10. The exposure apparatus according to claim 1, further comprising:
a position measuring system that measures the position at least within the two dimensional plane of the holding member held by the first moving body;
wherein,
the first and second stage units have a space, which is formed between the two second moving bodies, that passes through the first and second stage units in the second direction;
a measurement surface is provided on one surface of the holding member that is substantially parallel to the two dimensional plane;
the position measuring system comprises a measuring arm, at least part of which is disposed such that it opposes the measurement surface in the space of the first stage unit, that comprises a head, which radiates at least one measurement beam to the measurement surface and receives light of the measurement beam from the measurement surface, and has a cantilevered support structure that extends in the second direction and wherein the other side in the direction parallel to the second direction serves as a fixed end; and
based on the output of the head, the position measuring system measures the position at least within the two dimensional plane of the holding member held by the first stage unit.

11. The exposure apparatus according to claim 10, wherein
at least part of the holding member is a solid part wherethrough light can travel;
the measurement surface is disposed such that it opposes the solid part of the holding member on the object mounting surface side; and
the head is disposed such that it opposes the solid part on the side opposite the object mounting surface.

12. The exposure apparatus according to claim 10, wherein
a grating is formed on the measurement surface; and
the head radiates at least one measurement beam to the grating and receives a diffracted light of the measurement beam from the grating.

13. The exposure apparatus according to claim 12, wherein
the grating comprises first and second diffraction gratings, wherein the first direction and the second direction perpendicular to the first direction within the two dimensional plane are the direction of periodicity; and
the head radiates a first direction measurement beam and a second direction measurement beam, which correspond to the first and second diffraction gratings, as the measurement beams and receives diffracted lights of the first direction measurement beam and the second direction measurement beam from the grating, and, based on the outputs of the head, measures the position of the holding member in the first and second directions.

14. The exposure apparatus according to claim 13, wherein
the head radiates at least two measurement beams, whose irradiation points on the grating are different from one another in the first direction, as the second direction measurement beams to the second diffraction grating.

15. Then exposure apparatus according to claim 14, wherein
at least the two measurement beams and the first direction measurement beam are radiated to irradiation points on the same straight line on the grating parallel to the first direction.

16. The exposure apparatus according to claim 13, wherein
the measurement center, which is the center of the irradiation point of the second direction measurement beam radiated from the head to the grating, coincides with the exposure position, which is the center of an irradiation area of the energy beam radiated to the object.

17. A device fabricating method, comprising:
exposing an object using an exposure apparatus according to claim 1; and
developing the exposed object.
